(19) United States
(12) Patent Application Publication
(10) Pub. No.: US 2006/0060322 A1
(43) Pub. Date: Mar. 23, 2006

(54) Processing device for processing a coated or uncoated fibrous web

(76) Inventors: Mika Viljanmaa, Helsinki (FI); Juha Lipponen, Jarvenpaa (FI); Vilho Nissinen, Numminen (FI); Pekka Koivukunnas, Jarvenpaa (FI); Henri Vaittinen, Jarvenpaa (FI); Reijo Pietikainen, Jarvenpaa (FI); Kari Hasanen, Kerava (FI); Risto Sutti, Tampere (FI); Matti Lares, Tuusula (FI); Pekka Linnonmaa, Jarvenpaa (FI); Markku Kyytsonen, Numminen (FI); Matti Tervonen, Hyvinkaa (FI); Heikki Kettunen, Espoo (FI); Kari Holopainen, Muurame (FI)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/503,262

(22) PCT Filed: Jan. 29, 2003
(86) PCT No.: PCT/FI03/00067

§ 371 Date: Oct. 11, 2005

(30) Foreign Application Priority Data
Jan. 29, 2002 (FI) 20020159
Sep. 20, 2002 (FI) 2021673
Nov. 22, 2002 (FI) 2022082
Nov. 22, 2002 (FI) 20022083
Nov. 22, 2002 (FI) 20022084
Nov. 22, 2002 (FI) 20022085
Nov. 22, 2002 (FI) 20022086
Nov. 22, 2002 (FI) 20022087
Nov. 22, 2002 (FI) 20022088

(51) Int. Cl. D21G 1/00; D21F 3/00; B31F 1/07

(52) U.S. Cl. 162/206; 162/205; 162/359.1; 162/361; 428/141; 428/195.1; 428/340

(57) ABSTRACT

A processing device and a method applying the same for processing a coated or uncoated fibrous web is provided. The device comprises a belt configured to extend around a guiding element, at least one counter-element being disposed outside said belt to provide a contact area with the belt, such that the belt and the counter-element establish therebetween a web processing zone for passing a web to be processed therethrough. The processing zone length is defined by the disposition of the belt's guiding element and/or by the design of the counter-elements. A contact pressure applied to a web in the processing zone is configured to be within the range of between about 0.01 MPa and about 70 MPa.

The present invention relates to a processing device for processing a coated or uncoated fibrous web, such as e.g. paper, board or tissue, comprising a belt adapted to extend around at least one guiding element, at least one counter-element being disposed outside said belt to provide a contact area with the belt, such that the belt and the counter-element establish therebetween a web processing zone for passing a web to be processed therethrough. In the concept of this application, the term ‘web processing’ refers to a variety of measures associated with the treatment of a fibrous web produced in a paper/board machine, such as pressing, drying, calendering, coating, sizing. The processing device may also be a finishing device for a fibrous web, such as e.g. a separate coating device, a printing device or a calender.

Various belt calender solutions have been disclosed previously e.g. in Finnish patent 95061, as well as in Finnish patent applications FI 971343 and FI 20001025. However, these belt calenders are only suitable for calendering certain grades of paper or board.

Paper and board are available in a wide variety of types and can be divided according to basis weight in two grades: papers with a single ply and a basis weight of 25-300 g/m² and boards manufactured in multi-ply technology and having a basis weight of 150-600 m/m². It should be noted that the borderline between paper and board is vague, since board grades with lightest basis weights are lighter than the heaviest paper grades. Generally speaking, paper is used for printing and board for packaging.

The subsequent descriptions are examples of values presently applied for fibrous webs, and there may be considerable fluctuations from the disclosed values. The descriptions are mainly based on the source publication Papermaking Science and Technology, section Papermaking Part 3, edited by Jokio, M., published by Fapet Oy, Jyväskylä 1999, 361 pages.

Mechanical-pulp based, i.e. wood-containing printing papers include newsprint, uncoated magazine and coated magazine paper.

Newsprint is composed either completely of mechanical pulp or may contain some bleached softwood pulp (0-15%) and/or recycled fiber to replace some of the mechanical pulp. General values for newsprint can probably be regarded as follows: basis weight 40-48.8 g/m², ash content (SCAN-P 5:63) 0-20%, PPS s10 roughness (SCAN-P 76-95) 3.0-4.5 μm, Bendtsen roughness (SCAN-P21:67) 100-200 ml/min, density 600-750 kg/m³, brightness (ISO 2470:1999) 57-63%, and opacity (ISO 2470:1998) 90-96%.

Uncoated magazine paper (SC=supercalendered) usually contains mechanical pulp to 50-70%, bleached softwood pulp to 10-25%, and fillers to 15-30%. Typical values for calendered SC paper (containing e.g. SC-C, SC-B, and SC-A/A+) include basis weight 40-60 g/m², ash content (SCAN-P 5:63) 0-35%, Hunter gloss (ISO/DIS 8254/1) <20-50%, PPS s10 roughness (SCAN-P 76:95) 1.0-2.5 μm, density 700-1250 kg/m³, brightness (ISO 2470:1999) 62-70%, and opacity (ISO 2470:1998) 90-95%.

Table 1 discloses typical values for mechanical-pulp containing coated papers. (MFC=machine finished coated, FCO=film coated offset, LWC=light weight coated, MWC=medium weight coated, HWC=heavy weight coated)

TABLE 1

| | MFC | FCO | LWC | MWC | HWC |
|---|---|---|---|---|---|
| basis weight (g/m²) | 50-70 | 40-70 | 40-70 | 70-90 | 100-135 |
| Hunter gloss (ISO/DIS 8254/1), (%) | 25-40 | 45-55 | 50-65 | 65-70 | |
| PPS-s10 roughness, (μm) | 2.2-2.8 | 1.5-2.0 | 0.8-1.5 | 0.6-1.0 | |
| | | | (offset) | | |
| (SCAN-P 76/95) | | | 0.6-1.0 | | |
| | | | (roto) | | |
| density, (kg/m³) | 900-950 | 1000-1050 | 1100-1250 | 1150-1250 | |
| brightness (ISO 2470:1999), (%) | 70-75 | 70-75 | 70-75 | 70-75 | |
| opacity (ISO 2470:1998), (%) | 91-95 | 91-95 | 89-94 | 89-94 | |

Coated magazine paper (LWC=light weight coated) contains mechanical pulp to 40-60%, bleached softwood pulp to 25-40%, and fillers and coaters to 20-35%.

HWC can be coated even more than twice.

Chemical-pulp produced, woodfree printing papers or fine papers include uncoated—and coated—chemical-pulp based printing papers, in which the portion of mechanical pulp is less than 10%.

Uncoated chemical-pulp based printing papers (WFU) contain bleached birchwood pulp to 55-80%, bleached softwood pulp to 0-30%, and fillers to 10-30%. The values with WFU are highly unstable: basis weight 50-90 g/m² (up to 240 g/m²), Bendtsen roughness 250-400 ml/min, brightness 86-92%, and opacity 83-98%.

In coated chemical-pulp based printing papers (WFC), the amounts of coating vary widely in accordance with requirements and intended application. The following are typical values for once- and twice-coated, chemical-pulp based printing paper: once-coated basis weight 90 g/m², Hunter gloss 65-80%, PPS s10 roughness 0.75-2.2 μm, brightness 80-88%, and opacity 91-94%, and twice-coated basis weight 130 g/m², Hunter gloss 70-80%, PPS S10 roughness 0.65-0.95 μm, brightness 83-90%, and opacity 95-97%.

Release papers have a basis weight within the range of 25-150 g/m².

Other papers include e.g. sackkraft papers, tissues, and wallpaper bases. Board making uses chemical pulp, mechanical pulp and/or recycled pulp. Boards can be divided e.g. in the following main groups according to applications thereof.

Corrugated board, comprising a liner and a fluting.

Boxboards, used for making boxes, cases. Boxboards include e.g. liquid packaging boards (FBB=folding boxboard, LPB=liquid packaging board, WLC=white-lined chipboard, SBS=solid bleached sulphite, SUS=solid unbleached sulphite).

Graphic boards, used for making e.g. cards, files, folders, cases, covers, etc.

Wallpaper bases.

As can be appreciated from the above, there is a wide range of paper and board grades, and a multitude of various machines are used for making the same. It is an object of the present invention to provide a processing device and a method of operating the same, allowing the use of a highly extensive pressure range and application time (heat transfer time and/or processing time) in a processing zone, the same device being applicable for processing a Wide variety of coated and uncoated printing papers, boards and other papers, and being applicable e.g. as a preliminary calender upstream of coating, a finishing calender downstream of a paper machine or coating, a breaker stack, a wet stack calender, or as a dryer, a coater, a sizer, a printer and/or a press. The inventive device is conceivable as a replacement e.g. for a soft calender, a multi-nip calender, a machine calender, a shoe calender, or a Yankee cylinder.

In order to fulfil the objects of the invention, a device of the invention is characterized in that the processing zone length is defined by means of the disposition/adjustment of the belt's guiding element and/or by means of the design of the counter-elements, and that a contact pressure applied to a web in the processing zone is adapted to be adjustable within the range of about 0.01 MPa to about 200 MPa.

Contact pressure refers to the sum of pressure effects applied to a web within a processing zone between a belt and a counter-element, which are caused by a tension of the belt and/or by a compression force applied by possible intra-belt press elements. The pressure adjustment of a contact pressure to a certain pressure value or pressure range is effected by choosing a suitable belt material, which allows the use of a desired tightness or tension, and, if necessary, suitable press elements capable of increasing pressure over what is achieved by the belt alone. It should be noted that, depending on an assembly made up by belt and counter-elements, as well as by possible press elements, it is possible to cover either a part of the contact pressure adjustment range, the transition to another pressure value or pressure range being effected by replacing, if necessary, some of the elements included in the assembly, or to cover, with a suitable assembly, the entire contact pressure adjustment range, which can be e.g. from about 0.01 MPa to about 70 MPa or even from about 0.01 MPa to about 200 MPa. For example, the compression achieved by belt tension alone is remarkably insignificant when compared to the compression accomplished with press elements, whereby, in the solutions implemented without press elements, the adjustment range lies closer to a lower limit, e.g. within the range of about 0.01 MPa to about 5 MPa. When using press elements, the adjustment range can be e.g. from about 5 MPa to about 70 MPa, preferably from about 7 MPa to about 50 MPa or e.g. from about 70 MPa to about 200 MPa.

The inventive device comprises preferably a calender, a coater, a film advancer, a printer, a dryer, and/or a press.

In one application, the present invention relates to a method of making SC paper (supercalendered paper), in which method a paper web coming from the press section of a paper machine is carried through at least one calendering process, as well as to an SC paper grade produced by the method.

The following describes generally SC paper (supercalendered paper), with reference to the source publication Papermaking, Science and Technology, section Papermaking Part 3, Finishing, edited by Jokio, M., published by Fapet Oy, Jyväskylä 1999, 361 pages, pp. 53-68.

SC papers make up a product line, in which mechanical pulp is a dominating component and which has no coating. These products contain usually 50-75% mechanical pulp, 5-25% chemical pulp, and 10-35% a filler. The paper may also contain deinked waste pulp (DIP). Typical basis weights are 40-60 g/m².

Traditionally, SC paper is calendered with 10- to 12-roll supercalenders. Typically, 2 or 3 off-line calenders can handle the production of a single paper machine. Calendering speeds vary within the range of 500-700 m/min. Nip pressures are typically 300-400 kN/m, and the thermo roll has a water temperature within the range of 80-120° C. The two-sidedness of paper can be controlled by a reversed positioning of the top and bottom nips of the calender, by various temperatures and steaming levels.

Steaming of SC paper in a calender by means of steam injectors constitutes an essential part of SC calendering. Typically, a calender stack is provided with 3 or 4 steam boxes for upgrading the quality of paper. The recently installed steam boxes are zone-controlled and a feedback run control provides good gloss profiles in CD direction. Paper caliper is controlled with deflection-compensated top and bottom rolls.

SC-C and SC-B grades, which are intermediates between newsprint and smooth SC papers, can also be produced with two-nipped soft calenders. The surface temperature in running is 160-200° C. and nip pressures are up to 350 kN/m. Steaming is also an essential process in the calendering of these grades.

Polymer coats and high temperatures have been gradually adopted in the calendering of SC paper. The current trend is towards multi-nip calendering. Modern paper machines, running at the speed of 1800-2000 m/min, require as many as 4 supercalenders per paper machine. The latest calendering concepts allow higher calendering speeds, temperatures and nip pressures, by virtue of polymer coats. The number of rolls for the most demanding grades is 10 or 12.

An object of the invention is to provide a method, said method being capable of readily producing SC paper with desired properties and said method being capable of replacing the prior art calendering solutions while providing a number of benefits with respect thereto.

In order to achieve this object, the inventive method of making SC paper is characterized in that the calender used by the method in said at least one calendering process comprises a metal belt calender, comprising a metal belt adapted to extend around at least one guiding element, at least one counter-element being disposed outside said belt to provide a contact area with the belt, such that the belt and the counter element establish therebetween a web processing zone (or calendering zone) for passing a web to processed therethrough, the processing zone length in said metal belt calender being defined by means of the disposition/adjustment of the belt's guiding element and/or the design of the counter-elements, and that a contact pressure applied to the web in the processing zone is adjusted to lie within the range of about 0.01 MPa to about 200 MPa.

The inventive method of making SC paper comprises adjusting a contact time between a paper web and a metal belt conveniently to the range of about 5-200 ms, preferably to the range of about 20-80 ms, and adjusting the metal belt temperature conveniently to the range of about 20-400° C., preferably to the range of about 150-200° C. The moisture of a paper web arriving at the calender is adjustable within the range of about 1-65%, preferably within the range of about 8-15%, depending on a contact time with the metal belt and temperatures applied in calendering. Moistening can be effected by means of an on-line moistener upstream of the metal belt calender.

The counter-element for a metal belt comprises preferably an elastic surface roll, such as a polymer-covered roll, a rubber-covered roll, or an elastomer surface roll. Another conceivable solution comprises calendering SC paper between a thermo roll and a covered metal belt. When using a thermo roll, its temperature is adjusted conveniently to the range of about 20-400°, preferably to the range of about 150-200° C. The counter-element may also comprise something other than a roll, for example a shoe or bar assembly.

A metal belt calender used in the inventive method for making SC paper can be provided with at least one press element fitted inside the belt for compressing the belt against the counter-element for enhancing a pressure pulse applied to a web presently passing through the calendering zone. The press element comprises preferably a roll, which is adapted to subject the metal belt to a linear load of about 0-400 kN/m, preferably about 30-100 kN/m. The counter-element for a metal belt comprises preferably an elastic surface roll, such as a polymer-covered roll, a rubber-covered roll, or an elastomer surface roll. Another conceivable solution comprises calendering SC paper between a thermo roll and a covered metal belt. If a thermo roll is used, its temperature is adjusted conveniently to the range of about 20-400°, preferably to the range of about 150-200° C. The counter-element may also comprise something other than a roll, for example a shoe or bar assembly.

In one application, the present invention relates to a method of making mechanical-pulp containing coated paper, in which method a paper web, coming from the press section of a paper machine, is carried through at least one pre-calendering process upstream of a coating station and/or through at least one final calendering process downstream of the coating station, as well as to mechanical-pulp containing coated paper produced by the method.

The following describes generally mechanical-pulp containing coated paper, with reference to the source publication Papermaking, Science and Technology, section Papermaking Part 3, Finishing, edited by Jokio, M., published by Fapet Oy, Jyvaskyla 1999, 361 pages, pp. 53-68.

Wood-containing coated papers, such as MFC (machine finished coated), FCO (film coated offset), LWC (light weight coated), MWC (medium weight coated) and HWC (heavy weight coated), are often pre-calendered prior to coating and-final calendered after coating.

Mechanical-pulp containing coated papers contain usually 45-75% mechanical pulp and 25-55% chemical pulp. Fillers are not normally used, except for pigments originating from coated broke. The resulting amount of filler in base paper or stock is about 5-10%. A typical basis weight is 40-80 g/m².

An objective in pre-calendering is to reduce roughness and porosity to a required level prior to coating. Traditionally, LWC pre-calendering is performed with a two-roll machine calender, comprising one water-heated roll and one deflection-compensated roll. Nip pressures vary typically within the range of 10-40 kN/m and water temperature is generally 80-100° C.

Controlling paper thickness or caliper is an essential part of pre-calendering. Traditionally, the lateral or cross machine directed thickness profile is adjusted by means of hot/cold air jets, induction coils, and/or zone-controlled calender rolls. Recently developed individually zone-controlled rolls are capable of adjusting a cross-direction thickness profile without extra equipment.

Traditionally, final calendering of LWC and MWC paper is effected with 10- to 12-roll supercalenders. A typical assembly comprises two or three off-line supercalenders per one paper machine. The calenders have running speeds within the range of 600-800 m/min. Nip pressures are typically 300-350 kN/m and the thermo roll has a water temperature of 80-120° C.

Final calendering of film-coated offset paper (FCO) is effected with either 12-roll supercalenders or two-nipped on-line soft calenders. Soft calendering requires quite severe calendering conditions, roll temperatures up to 200° C. and nip pressures up to 350 kN/m. Final calendering of MFC paper is effected with a two-nipped on-line soft calender in comparatively mild calendering conditions, as a result of modest aspirations in terms of gloss. Roll temperatures are typically 70-90° C. and nip pressures 70-120 kN/m.

Polymer coats and high temperatures are highly useful in LWC calendering. Modern paper machines, with running speeds of 1800-2000 m/min, require as many as four supercalenders per paper machine. The recently developed multi-roll calender concepts permit considerably higher running speeds.

An objective of the invention is to provide a method, said method being readily capable of producing wood-containing coated paper with desired properties, and said method being capable of replacing the prior art pre-calendering and/or final calendering solutions while providing several benefits with respect thereto.

In order to fulfil this objective of the invention, the inventive method of making mechanical-pulp containing coated paper is characterized in that the method employs in the pre-calendering process and/or in the final calendering process a processing device, comprising a metal belt adapted to extend around a guiding element, at least one counter-element being disposed outside said belt to provide a contact area with the belt, such that the belt and the counter-element establish therebetween a web processing zone for passing a web to be processed therethrough, the processing zone length in said processing device being defined by means of the disposition/adjustment of the belt's guiding element and/or the design of the counter-elements, and that a contact pressure applied to the web in the processing zone is adjusted to lie within the range of about 0.01 MPa to about 200 MPa.

Mechanical-pulp containing coated paper produced by a method of the invention is characterized in that the surface has a PPS s10 roughness (SCAN-P 76:95) of 0.4-5.0 μm and/or a Bendtsen roughness (SCAN-P21:67) of 0.1-300 ml/min and/or a density (SCAN-P7:75) of 600-1500 kg/M³. Especially, the surface has a PPS s10 roughness (SCAN-P 76:95) of 0.6-2.8 μm. The Bendtsen roughness (SCAN-P21:67) of the surface is preferably 5-100 ml/min.

The method of making mechanical-pulp containing coated paper comprises the adjustment of a contact time between a paper web and a metal belt conveniently to the range of about 5-200 ms, preferably to the range of about 20-80 ms, and the adjustment of a metal belt temperature conveniently to the range of about 20-400° C., preferably to the range of about 150-200° C. The moisture of a paper web arriving at the calender is adjustable within the range of about 1-65%, preferably within the range of 8-15%, depending on contact times with a metal belt and temperatures applied in calendering. Moistening can be effected by means of an on-line moistener upstream of the metal belt calender. The counter-element for a metal belt comprises preferably a thermo roll or an elastic surface roll, such as a polymer-covered roll, a rubber-covered roll, or an elastomer surface roll. The counter-element may also be something other than a roll, for example a shoe or bar assembly. When using a thermo roll, its temperature is adjusted conveniently to the range of about 20-400° C., preferably to the range of about 150-200° C. A metal belt calender for use in the inventive method of making mechanical-pulp containing coated paper can be provided with at least one press element fitted inside the belt for compressing the belt against the counter-element for enhancing a pressure pulse applied to a web passing through the processing zone. The press element comprises preferably a roll, which is adapted to subject the metal belt to a linear load of about 0-400 kN/m, preferably about 30-100 kN/m. The press element may also be something other than a roll, for example a shoe or bar assembly.

In a method of the invention for making mechanical-pulp containing coated paper, the metal belt pre-calendering is preferably combined with the metal belt final calendering, but the final calendering can also be performed by means of currently available final calendering solutions which, by virtue of metal belt pre-calendering, can be made lighter regarding the extent of final calendering. In a method of the invention for making mechanical-pulp containing coated paper, it is also feasible to employ currently available pre-calendering solutions and to perform final calendering with a metal belt calender for obtaining various benefits; e.g. producing an equal grade of paper with a considerably lower number of nips by virtue of an effective processing zone and, in addition, a metal belt calender is much more attractive in terms of costs than a multi-roll calender.

One application of the present invention relates to a method of making newsprint, and to a newsprint grade produced by the method.

The following describes newsprint with reference to the source publication Papermaking Science and Technology, section Papermaking Part 3, Finishing, edited by Jokio, M., published by Fapet Oy, Jyväskylä 1999, 361 pages, pp. 53-68.

Newsprint grades contain usually 75-100% mechanical pulp, 0-25% chemical pulp, and a maximum amount of filler is 8%. The paper pulp may contain mechanical fiber, or recycled fiber even up to 100%. Recycled fiber may have a higher filler content than papers made of virgin fibers (even as high as 20%).

Newsprint is calendered in a paper machine with an on-line calender. Traditionally, this is done by using a 4- to 6-roll hard nip calender. Newsprint has usually a running speed of 1100 m/min to 1700 m/min. Nip pressures are 80-100 kN/m and thermo roll water temperatures are 80-120° C.

Controlling paper thickness is an essential part of a newsprint calender. Traditionally, the cross-direction or lateral thickness profile has been controlled by means of hot/cold air jets, induction coils, and/or zone-controlled calender rolls. Modern zone-controlled rolls are capable of adjusting a cross-direction thickness profile without extra equipment.

Since the texture of paper has become more readily workable than it used to be (more deinked waste pulp (DIP), more fines) and the former, as well as the press, are capable of providing improved toughness, the trend has been towards reducing the number of nips in calenders, and thus the nip pressure.

Typical running conditions in a soft calender for newsprint, provided with a DIP base, are 20-80 kN/m in two soft nips and a temperature of 80-100° C. In some cases, even a single soft nip is sufficient, depending on the two-sidedness of paper (which depends on the design of a paper machine's press section).

TMP-based newsprint requires two soft calender nips and fairly harsh calendering conditions. Nip pressures vary typically within the range of 250-350 kN/m and a temperature up to 160° C. TMP-based pulp compositions require also steaming for enhanced calendering action. Steaming has been used with highly effective results in modern paper machines provided with one-sided drying for controlling a curling tendency. When dealing with coarse pulp compositions, pre-calendering has been considered also for the dryer section (an intermediate calender or breaker stack).

It is an object of the invention to provide a method, which method is readily capable of producing newsprint with desired properties and which method enables replacing prior art calendering solutions while providing a number of benefits with respect thereto.

In order to fulfil the objective of the invention, a method of the invention for making newsprint is characterized in that the calender used by the method in at least one calendering process comprises a processing device, comprising a metal belt adapted to extend around a guiding element, at least one counter-element being disposed outside said belt to provide a contact area with the belt, such that the belt and the counter-element establish therebetween a web processing zone for passing a web to be processed therethrough, the processing zone length being defined in said processing device by means of the disposition/adjustment of the belt's guiding element and/or the design of the counter-elements, and that a contact pressure applied to the web in the processing zone is adjusted to lie within the range of about 0.01 MPa to about 70 MPa.

A newsprint grade produced by the inventive method is characterized in that the surface has a PPS s10 roughness (SCAN-P 76:95) of 2.5-7.0 μm and/or a Bendtsen roughness (SCAN-P21:67) of 30-600 ml/min. Preferably, the surface has a PPS s10 roughness (SCAN-P 76:95) of 3.5-5.0 μm. The Bendtsen roughness (SCAN-P21:67) is preferably 40-200 ml/min.

In a method for making newsprint, the contact time of a paper web with a metal belt is adjusted conveniently to the range of about 5-200 ms, more preferably to the range of about 20-80 ms, and the metal belt temperature is conveniently adjusted to the range of about 20-400° C., more preferably to the range of about 150-200° C. The moisture of a paper web arriving at the calender is adjustable within the range of about 1-65%, preferably within the range of about 8-15%, depending on a contact time with the metal belt and temperatures applied in calendering. Moistening can be effected by means of an on-line moistener upstream of the metal belt calender. The counter-element for a metal belt comprises preferably a thermo roll or an elastic surface roll, such as a polymer-covered roll, a rubber-covered roll, or an elastomer surface roll. The counter roll may also be something other than a roll, for example a shoe or bar assembly. When using a thermo roll, its temperature is adjusted conveniently to the range of about 20-400° C., more preferably to the range of about 150-200° C.

The metal belt calender for use in a newsprint making method of the invention can be provided with at least one press element disposed inside the belt for compressing the belt against a counter-element for enhancing a pressure pulse applied to a web passing through a processing zone. The press element comprises preferably a roll, which is adapted to apply against the metal belt a linear load of about 0-400 kN/m, preferably about 30-100 kN/m. The press element may also comprise something other than a roll, for example a shoe or bar assembly.

In a method of the invention for making newsprint, the calendering is preferably performed as final calendering in a single process downstream of the dryer section, but the metal belt processing device can also be located within the dryer section or both within and downstream of the dryer section.

One application of the present invention relates to a method of making coated, chemical-pulp based fine grade paper (WFC), and to a coated, chemical-pulp based printing paper grade produced by the method.

The following description regarding chemical-pulp based printing papers (woodfree coated=WFC) relies on the source publication Papermaking Science and Technology, section Papermaking Part 3, Finishing, edited by Jokio, M., published by Fapet Oy, Jyväskylä 1999, 361 pages, pp. 53-68.

Coated, chemical-pulp based printing paper grades are used for high-standard printing applications, such as art books, brochures, and annual reports. Requirements regarding the end use of a paper grade determine the amount, gloss objectives and other specifications of an applied coating ink. WFC grades can be coated once, twice, or three times. The total coating layer can be as high as 40 g/m² per side. WFC production involves the use of pre-calenders prior to a coating device in an effort to calender the surface according to requirements characteristic of the coating device. The ultimate surface can have a matte or glossy finish. Some grades are printed either in sheet form or in reels. All these fluctuations in paper texture, surface finish, or formation are factors regarding the applied calendering concept for attaining grade-specific quality standards.

The purpose of pre-calendering is to reduce roughness and porosity to required level upstream of a coating device. Traditionally, WFC pre-calendering has been effected with a two-roll machine calender, comprising one water-heated roll and one deflection-compensated roll. Nip pressure varies typically with the range of 10-40 kN/m and temperature within the range of 80° C.-100° C. Soft calendering is also used more and more as a pre-calendering process due to a good control over two-sidedness and a good calendering result. An important aspect in the pre-calendering of wood-containing coated grades is controlling paper thickness.

At present, the most typical final calendering process for WFC grades is supercalendering. Typically, two off-line supercalenders are capable of handling the production of a single paper machine. The calenders' running speeds vary within the range of 500-1200 m/min. A matte surface finish can be typically achieved by on-line calendering in coating machines, with the use of one or two soft nips (soft-soft rolls).

Novel multi-roll calenders constitute an increasing technology with regard to glossy WFC grades. Elevated temperatures, together with polymer-covered soft rolls and sophisticated loading systems, assist in reducing nip pressures required for attaining quality standards, with resulting savings in bulk.

New multi-roll calenders can be sued for producing WFC grades with a variety of calender configurations. A modern calender can achieve production targets by using a system, which includes 8-12 rolls. Selection of the most appropriate option must be judged on the basis of resulting quality, since the quantity is no longer of primary interest. The calendering principle with an 8-roll calender, used for the same production as a 12-roll calender, is somewhat different. The 8-roll stack requires more load and heat. Highly favourable results have been obtained by using a plurality of lightly loaded nips as compared to fewer excessively loaded nips. This favours a 12-roll calender over an 8-roll version.

Elevated temperatures in the process of calendering WFC grades provide quality-related benefits in the form of higher gloss with a standard bulk. When comparing a standard supercalender, operating with filled rolls and at a temperature level of 80° C., with a modern multi-roll calender, provided with polymer rolls and higher temperatures, there is a perceivable increase of 4-5% in Hunter gloss, while the paper density level is constant. Some loss of brightness has been experienced in a few cases in conjunction with higher-temperature calendering. This risk can be eliminated by keeping the paper winding temperature sufficiently low (35° C.-45° C.).

The impact of soft surface rolls on WFC calendering is highly significant. The objective is to avoid coats with an excessively high modulus, i.e. a nip which is too hard. Suitable coats have normally a hardness which is within the range of 88-91 ShD. A coating, which is too hard, can cause uneven calendering (inconsistency of gloss). This concerns the formation of paper, as well. The better the formation, the lower the risk when using harder coats (higher modulus).

WFC matte or dull surface grades constitute an increasing share of overall WFC production. Typically, the Hunter gloss (ISO/DIS 8254/1) is kept at a level below 35%. The human eye perceives paper as having a matte finish when the level of gloss is lower than this value. The minimization of gloss is not critical; a sufficiently low level is enough. Calendering this matte finish means less calendering work on paper, typically with a few nips only. For the same reason, the calendering temperature is low. Matte finish is usually produced by means of an on-line soft calender, provided with two soft rolls to establish a nip.

One conventional solution for matte finish production is to use a supercalender, having a certain web run which bypasses some of the nips.

An objective in matte finish calendering can be expressed as gloss and smoothness of paper. A target is to maximize smoothness and minimize gloss at the same time. In matte finish production, the composition of a coating slip has an important role. Selecting correct components for the recipe of a coating slip can readily have an impact on a gloss/smoothness relationship in calendered paper. Sheet type pigments, such as clay, and highly gloss-promoting pigments, such as plastic pigments, are not employed in matte finish slips.

In matte finish production, the softness of a nip becomes a critical calendering parameter. Since paper is subjected to only mild calendering, it is necessary to have low nip pressures for attaining target quality standards. If the nip is too hard, i.e. the soft coating has a high elastic modulus, the result may be inconsistency of gloss.

New multi-roll calenders provide good tools for matte finish production. By taking full advantages of novel loading systems, it is possible to run a multi-roll calender with a sufficiently low calendering effect on paper, without the paper being overglazed in a finishing process. It is also conceivable to use specially coated/embossed or patterned rolls, which reduce roughness, yet do not create too much gloss. The quality of WFC paper is more often judged on the basis of printed visual appearance than by observing blindly measured properties of paper.

In coated, chemical-pulp based printing papers (WFC), the amounts of coating vary over a wide range according to requirements and intended application. The following are typical values for once and twice coated chemical-pulp based printing paper:

coated once: basis weight 90 g/m², Hunter gloss 65-80%, PPS-s10 roughness 0.75-1.1 μm, brightness 80-88%, and opacity 91-94%

coated twice: basis weight 130 g/m², Hunter gloss 70-80%, PPSs10 roughness 0.65-0.95 μm, brightness 83-90%, and opacity 95-97%.

It is a target of the present invention to provide a novel method for making coated fine paper grades, which method brings about several benefits with respect to prior art methods.

In order to reach the target of the invention, a method of the invention for making coated, chemical-pulp based fine paper (WFC) is characterized in that the calender used by the method in a pre-calendering process and/or in a final calendering process comprises a processing device, comprising a metal belt adapted to extend around a guiding element, at least one counter-element being disposed outside said belt to provide a contact area with the belt, such that the belt and the counter-element establish therebetween a web processing zone for passing a web to be processed therethrough, the processing zone length in said processing device being defined by means of the disposition/adjustment of the belt's guiding element and/or the design of the counter-elements, and that a contact pressure applied to the web in the processing zone is adjusted to lie within the range of about 0.01 MPa to about 70 MPa.

A coated, chemical-pulp based printing paper grade produced by a method of the invention is characterized in that the surface has a PPS s10 roughness (SCAN-P 76:95) of 0.4-3.0 μm and/or a gloss (ISO/DIS 8254) of 40-90%. Preferably, the surface has a PPS s10 roughness of 0.6-1.5 μm. The gloss is preferably 60-80%. The printing paper manufactured according to the invention comprises conveniently a printing grade paper, which is coated at least once over each side thereof.

One application of the present invention relates to a method for making uncoated, chemical-pulp based fine paper (WFU), which method is readily capable of producing paper with desired properties (especially a good interrelation between Bendtsen roughness and PPS roughness). The invention relates also to uncoated, chemical-pulp based fine paper (WFU) produced by the method.

The following describes uncoated chemical-pulp based printing paper grades (WFU=woodfree uncoated), with reference to the source publication Papermaking Science and Technology, section Papermaking Part 3, Finishing, edited by Jokio, M., published by Fapet Oy, Jyväskylä 1999, 361 pages, pp. 53-68.

Uncoated woodfree printing papers are particularly used as papers for copiers and printers. They contain bleached birchwood pulp to 55-80%, bleached softwood pulp to 0-30%, and fillers to 10-30%. In WFU, the values vary widely, with basis weight 50-90 g/m² (even as high as 240 g/m²), Bendtsen roughness 250-400 ml/min, brightness (ISO 2470:1999) 86-92%, and opacity (ISO 2470:1998) 83-98%.

For example, in reference to standard copying paper, typical values are as follows:

| | |
|---|---|
| Basis weight (g/m²) | 80 |
| PPS roughness, μm | 3.5-5.0 |
| Bendtsen roughness, ml/min | 100-200 |
| Hunter gloss, % | 7-15 |

The end use of paper grades intended for copiers and printers is substantially different from that of conventional printing papers. Dimensional stability and resistance to curling or warping are critical factors in printers applying one-sided heating. Four-colour printing also requires a high-quality surface finish. Traditionally, WFU grades have been calendered in paper machine with an on-line hard nip calender provided with one or two nips. Typical running speeds are moderate, in the order of 700-1100 m/min. Soft calendering is regarded at present as primary technology for WFU grades. Multi-roll calendering is also feasible in connection with WFU grades.

It is an object of the present invention to provide a novel method for making uncoated fine papers, the paper obtained as a result of said method having e.g. a high large-scale smoothness (a low Bendtsen roughness) as compared with machine-calendered or soft-calendered paper, and higher strengths than machine-calendered paper.

In order to accomplish such object of the invention, a method of the invention for making uncoated fine paper grades is characterized in that a paper web coming from the press section of a paper machine is guided in the method to a processing device, located in the dryer section and/or downstream of the dryer section and/or web sizing and comprising a metal belt adapted to extend around a guiding element, at least one counter-element being disposed outside said belt to provide a contact area with the belt, such that the belt and the counter-element establish therebetween a web processing zone for passing a web to be processed therethrough, the processing zone length in said processing device being defined by means of the disposition/adjustment of the belt's guiding element and/or the design of the counter-elements, and that a contact pressure applied in the method to the web in the processing zone is adjusted to lie within the range of about 0.01 MPa to about 70 MPa.

An uncoated, chemical-pulp based fine paper grade produced by a method of the invention is characterized in that the surface has a PPS s10 roughness (SCAN-P 76:95) of 1.0-7.0 μm and/or a Bendtsen roughness (SCAN-P21:67) of 10-800 ml/min. Preferably, the surface has a PPS s10 roughness (SCAN-P 76:95) of 3.5-5.0 μm. The Bendtsen roughness (SCAN-P21:67) is preferably 50-200 ml/min. The coated, chemical-pulp based fine grade paper (WFU), manufactured by a method of the invention, comprises preferably copying paper, colour copying paper, or it is used for making envelopes, books, operating manuals.

One application of the present invention relates to a method for making release paper, a paper web coming from the press section of a paper machine being guided in said method through at least one calendering process, as well as to a release paper grade produced by the inventive method.

The following description deals with release paper, with reference made to the source publication Papermaking Science and Technology, section Papermaking Part 3, Finishing, edited by Jokio, M., published by Fapet Oy, Jyväskylä 1999, 361 pages, pp. 53-68.

Release papers are used as base papers or stocks for self-adhesive products for various end applications, such as food packages or office labels. The most common release paper in Europe is supercalendered glossy paper, which is coated with silicone for good release properties.

Table 2 discloses typical values for supercalendered release paper.

TABLE 2

| | | |
|---|---|---|
| basis weight, (g/m²) | 60-65 | 80-90 |
| Thickness, μm | 55-57 | 71-79 |
| density, (kg/m³) | 1080-1200 | 1150-1250 |
| Cobb Unger (g/m²) | | |
| (SCAN-P 37:77) | | |
| dense side | 0.9-1.4 | 1.0-1.6 |
| open side | 1.2-2.5 | 1.8-2.2 |

Calendering-influenced critical properties of release paper include a high silicone absorption resistance (high density and smoothness), a uniform silicone absorption, and a uniform thickness profile in CD-direction. In some grades, high transparency is also needed.

At present, release paper is calendered with off-line supercalenders. The typical number of nips ranges from 11 to 17. There is no reverse nip, as the treatment is applied to one side only (silicone side). The soft rolls can be paper or polymer rolls. The thermo roll has its surface temperature varying within the range of 90-140° C. The lowermost nip has a maximum nip pressure of 450-500 kN/m. Paper is moisturized before the paper machine reel for a high moisture content, 15-20%. This is needed to gain high density and a closed surface. Because of a high moisture content, drying is needed after calendering. Drying is typically performed by means of air driers. The final moisture is 5-7%. The typical running speed varies within the range of 300-500 m/min. Release paper requires two supercalenders per one paper machine.

An object of the invention is to provide a method, which method is readily capable of producing release paper with desired properties, and which method is capable of replacing prior known calendering solutions while offering several benefits with respect thereto.

In order to achieve this object of the invention, a method of the invention for making release paper is characterized in that the calender used by the method in said at least one calendering process comprises a processing device, comprising a metal belt adapted to extend around a guiding element, at least one counter-element being disposed outside said belt to provide a contact area with the belt, such that the belt and the counter-element establish therebetween a web processing zone for passing a web to be processed therethrough, the processing zone length in said processing device being defined by means of the disposition/adjustment of the belt's guiding element and/or the design of the counter-elements, and that a contact pressure applied to the web in the processing zone is adjusted to lie within the range of about 0.01 MPa to about 200 MPa.

A release grade paper, manufactured by a method of the invention, is characterized in that the release paper has a basis weight of 40-100 g/m² (SCAN-P 6:75) and/or a density of 800-1400 kg/M³ (SCAN-P7:75), the release paper having preferably a basis weight of 60-90 g/m² (SCAN-P 6:75). The release paper produced by a method of the invention has preferably a density of 1000-1260 kg/M³ (SCAN-P7:75).

One application of the invention relates to a board product and its manufacture. One object of the invention is to upgrade the quality and manufacturing economy of board products, especially boxboard.

Boxboard is required to have a specific surface quality for ensuring a desired gloss and printing quality, stiffness and tearing strength for ensuring the functionality of a package. Moreover, since a board mill produces board in great quantities, the efficient use of raw stock is important. These demands are partly contradictory with each other. Board is provided with a sufficient gloss by calendering the board by compressing the same in a nip, often in a moistened and heated condition. Preferably, this compression flattens the fibers and coating of a board surface, yet without compacting the inner layer of board. Compaction of the inner layer diminishes the stiffness of board and reduces its tearing strength. This compaction of the inner layer is referred to as a loss of bulk. In this case, the tern bulk refers to the inverse value of density and, thus, its loss indicates the compaction of paper or board to a dense condition.

Since paper and board production is highly raw-stock intensive, even a small saving in stock provides a substantial advantage over competitors. In this respect, even a one-percent saving can be regarded as a major competitive advantage and the restitution time of investment is short. In addition, saving in raw stock is desirable from the environmental perspective. By virtue of a lighter-than-before texture, the board of this invention has its multiplicative effects extending over the entire service life of a product, since a reduced consumption of raw stock results in a lighter package which ultimately leads to savings also in shipping services and in a reduced quantity of waste.

Packaging boards are often coated or multilayer structures. Typically, the basic board consists of three fibrous layers, the topliner and the bottom layer comprising bleached chemical pulp. The middle or body layer comprises often mechanical pulp, typically groundwood (GW), but often also pressure groundwood (PGW) and chemithermo-mechanical pulp (CTMP). In addition, the middle layer uses broke or reject. Binders and pigments are also often used for conditioning surface properties, for example for watertightness. A typical basis weight range for boxboards is 180-350 g/m². The required basis weight depends on stiffness necessary for a package, a lighter board being sufficient for small packages. If surface treatment is managed with savings in board bulk and hence a stiffer board is produced, the result is savings in raw stock and energy as this enables the use of a board with a lower basis weight.

Boxboards are often smoothed prior to coating with a Yankee cylinder, which provides a good bulk and stiffness, the surface properties being also good and, likewise, the drying shrinkage along the edges being small, yet speed restraints, space requirements for equipment, and the enormous size of a Yankee cylinder in a high-speed machine restrict the use of a Yankee cylinder. A wet-stack calender is a typical processing method for SBS board, its problems including runnability problems and control over the application of water, and, since the board must be dried before and after calendering, this incurs extra cost. Various soft or long-nip calender solutions have also been tested with encouraging results. A problem with a long-nip calender based on a soft belt and shoe remains to be the fluctuation of quality in offset-printed board caused by a soft belt and difficulties in the control of running parameters.

A machine calender is often used together with other calenders, the machine calender referring to a hard calender whose rolls are not elastic. The machine calender is not preferred as a sole surface treating method. The soft calender is a soft-nip calender, in which the calender surface is elastic, the surface having possibly a hardness which is in the same order as the surface hardness of wood, yet being elastic. Hence, it is an object of this invention to provide a flat printing surface, a high gloss and stiffness for boxboard with a lower-than-before consumption of material. These objects are accomplished by means of a packing board set forth in claim 116 and a method set forth in claim 133 for making a coated board product.

According to the invention, boxboard is treated with a processing device of claim 1 prior to or during its coating. The calendering nip can have a considerable length and, in addition, the metal belt is locally fairly hard, thus, in terms of surface smoothness, the calendering result will be better than what is achieved by using soft long-nip calenders. Moreover, by virtue of a long action time and a low calendering pressure, the result will be a high surface quality without a loss of bulk. The metal belt can be preferably heated to a relatively hot condition for creating a powerful thermal gradient for the duration of calendering. In addition, the metal belt can be used for providing a calendering nip of considerable length, the long nip providing an increased action time for calendering and pressing the surface fibers into a more firm and permanent contact with the surface, yet without diminishing bulk.

A metal belt calender may function with a pressure produced only by a tension of the belt, or by using belt compressing press elements in addition to the pressure produced by a tensioned belt. Because of machine slowness, the production of boxboard involves a fairly long action time in the calender and the web is relatively narrow. For these reasons, it is possible to use a metal belt alone, even without press elements. By means of compression executed by a belt alone, it is possible to attain contact pressures of about 0.01 MPa to about 5 MPa. The deployment of press elements means that the attainable contact pressures will be about 0.01 MPa to 70 MPa.

It is preferred that the processing of many grades of boxboard be performed by using nothing but the tension of a belt or by using fairly minor extra compression in addition to a pressure produced by belt tension.

The processing device for a board of the invention comprises preferably a calender and/or a coater, a sizer, a printer, a dryer, and/or a press. The board to be processed with a processing device of the invention can also be uncoated.

One application of the present invention relates to a safety paper, and to a mechanism and a method for making the safety paper. In this context, the term safety paper refers to paper or board, which can be used e.g. as a printing surface or a packing material and which is inherently difficult to manufacture without appropriate equipment, in other words, its falsification is difficult.

Traditionally, safety paper has been provided with diverse colour or fluorescent fibers, holograms, watermarks, etc. to verify the authenticity and origin of paper or, for example, a board-made package. Such solutions are nevertheless expensive and principally applicable to currency papers or other products, which have a high ratio of value to manufacturing costs.

Publications WO/0198588 and U.S. Pat. No. 6,402,888 disclose methods, wherein paper is identified by providing the paper with domains distinguished from surrounding areas, i.e. designs or, for example, text. More specifically, paper is provided with domains, having a lesser thickness when compared to the rest of a fibrous web and being clearly distinctive from the rest of the paper surface by naked eye. However, these methods are only applicable to certain types of multilayer papers or boards. Moreover, the safety paper manufacturing method disclosed in the former of these cited publications requires multiple distinct processes for making a final product, including also finishing processes (coating) after the formation of designs or devices used for identifying the paper. On the other hand, the safety paper disclosed in the latter of-these publications is composed of two fibrous webs formed in two separate wet ends of a paper machine by joining and drying the same in the paper machine. Consequently, such methods are complicated and expensive.

Publication U.S. Pat. No. 6,174,586 discloses another method for making safety paper. Here, the devices or text used for identifying the paper are only formed either as embossments or impressions on a coating to be laid on paper surface. Such a method is also applicable to just certain types of paper grades, especially those to be coated. Besides, the method is slow and, hence, its application as an on-line process in a paper machine is difficult.

It is an object of the present invention to provide a safety-marked paper or board, which is simple. fast and economical to produce, as well as a method and a mechanism for making such paper or board, and even in such a way that the method and the device are highly suitable for both uncoated and coated paper and board grades.

The implementation is such that identified safety paper is manufactured by calendering a fibrous web with a calender, preferably a metal belt calender, wherein at least one calendering surface is engraved with impressions consistent with the shapes of designs or devices used for identifying the paper, for example a company's logo or some text, in such a way that the areas of a fibrous web coinciding with the impressions during the process of calendering the fibrous web remain uncalendered or less calendered, said uncalendered or less calendered areas being clearly distinctive from the rest of the calendered surface of the fibrous web.

Thus, one target of the present invention is to provide a method and a mechanism for making safety paper, more specifically to a fibrous web conditioning mechanism and a method of operating the same, which is well adaptable to various paper and board grades as exemplified above.

The inventive safety paper is characterized in that, in the process of calendering a fibrous web, at least one side thereof is left with uncalendered or less calendered areas consistent in shape with a desired design, said uncalendered or less calendered areas being clearly distinctive from the rest of the calendered surface of the fibrous web.

The inventive method for manufacturing safety paper composed of a calendered fibrous web is characterized in that, in at least one calendering process of a fibrous web, at least one side thereof is left with uncalendered or less calendered areas consistent in shape with a desired design, said uncalendered or less calendered areas being clearly distinctive from the rest of the surface of the fibrous web.

In order to fulfil the inventive objects, a device of the invention is in turn characterized in that at least one calendering surface is provided with impressions consistent with areas identical in shape to desired designs and intended for the surface of a fibrous web, such that the areas of a fibrous web coinciding with the impressions during the process of calendering the fibrous web remain uncalendered or less calendered, said uncalendered or less calendered areas being clearly distinctive from the rest of the calendered surface of the fibrous web.

The present invention offers numerous benefits over prior art techniques. Paper or board manufactured by calendering with engraved surfaces are very difficult to falsify or counterfeit, since it is highly difficult to provide an already calendered surface with a pattern which would resemble an uncalendered surface or such a surface which has received less calendering than the rest of the surface.

The inventive mechanical and simple method is highly suitable for various types of uncoated or coated paper and board grades. The method provides a highly simple, fast, and economical means of manufacturing safety paper and excellently applicable as an on-line process in a paper machine.

The solution is readily adaptable e.g. to the identification of packaging materials, such as cigarette packs, cardboard boxes for CDs, etc., the forgery of which is fairly widespread at present.

A processing device of the invention and various applications thereof will now be described in more detail with reference to the accompanying drawings, in which:

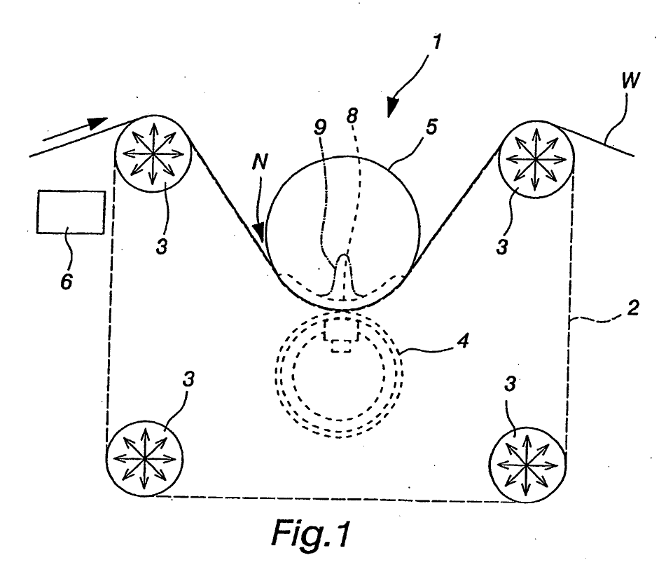

FIG. 1 shows a metal belt calender of the invention in one embodiment,

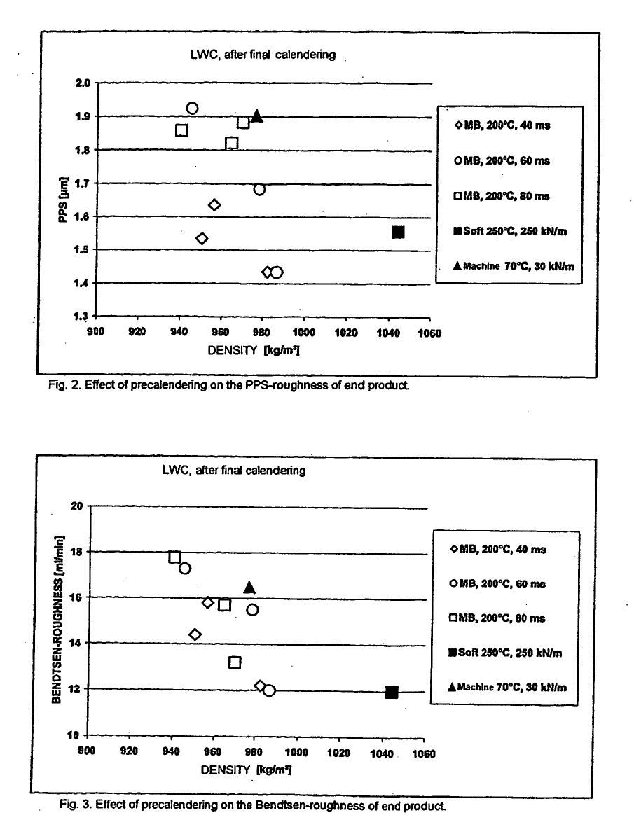

FIGS. 2 and 3 illustrate laboratory-scale test results for LWC paper obtained by a pre-calendering method of the invention for making mechanical-pulp containing coated paper, as compared with currently available methods,

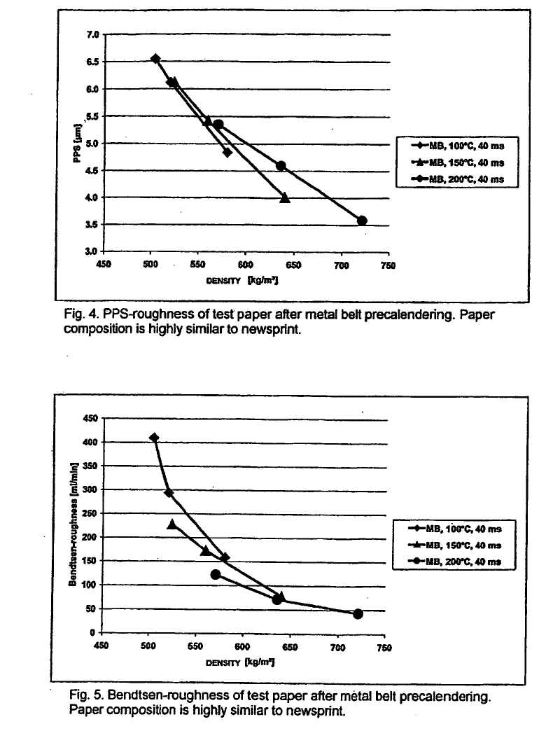

FIGS. 4 and 5 illustrate test results obtained by a method of the invention for making newsprint, in case of paper whose composition is consistent with that of newsprint,

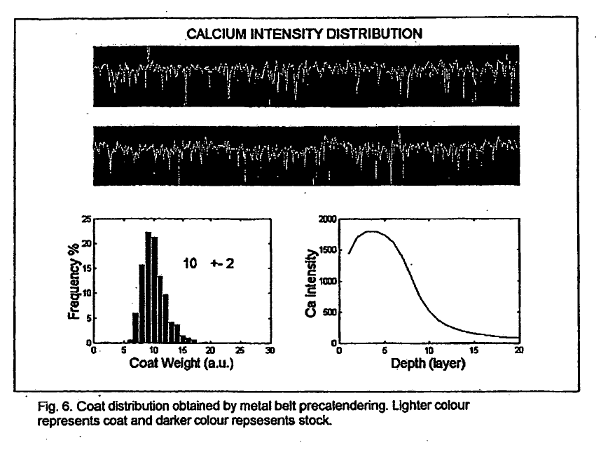

FIGS. 6-10 illustrate test results obtained for coated fine papers obtained by a method of the invention and a few other methods,

FIGS. 11 and 12 illustrate test results obtained for fine papers obtained by a method of the invention and a few other methods,

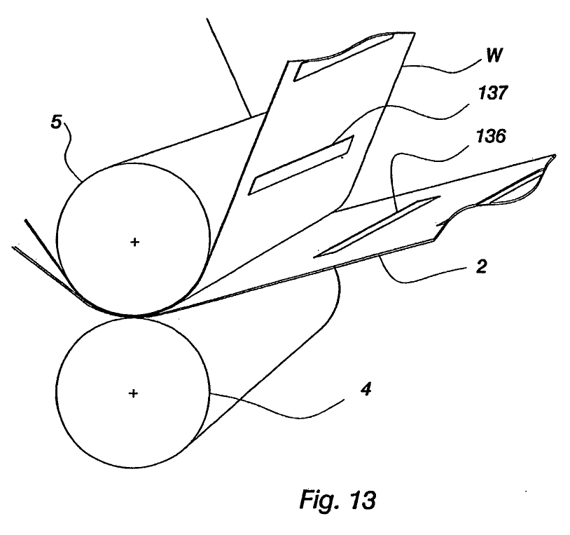

FIG. 13 shows in an oblique side view a section of the belt calender of FIG. 1, illustrating specifically the areas left uncalendered on the surface of a fibrous web.

In reference to FIG. 1, there is shown one device of the invention implemented as a metal belt calender, comprising a metal-constructed calendering belt 2 extending around guiding rolls 3, at least some of said guiding rolls being movable for adjusting the belt 2 to a desired tension. The calendering belt 2 travels around a roll 5 disposed outside the belt loop, a calendering zone being established between the belt 2 and the roll 5. A to-be-calendered web W travels through the calendering zone, being subjected to a desired pressure impulse and thermal effect as a function of time. In FIG. 1, a dash-and-dot line 9 represents a pattern of pressure impulse whenever the calendering belt 2 is provided on the inside thereof with a press roll 4 functioning as a press element for compressing the belt against the roll 5 so as to establish a higher-pressure processing zone within the calendering zone. On the other hand, a dash-and-dot line 8 represents a pattern of pressure impulse whenever a contact pressure existing within the calendering zone is established only by means of a tension of the belt 2, the roll 4 being out of a compressing contact with the belt 2 (or when there is actually no roll 4 installed inside the belt 2). The roll 5, as well as the roll 4, may or may not comprise a deflection-compensated roll and is selected from a group, including: an elastic surface roll, such as a polymer-covered roll, a rubber-covered roll, or an elastomer surface roll, a shoe roll, a, a metal roll, a filled roll, and a composite roll. Instead of the roll 4, the press element may comprise also some other profitable or fixed-profile press element, which may also be composed of several elements successive in the cross machine direction. Also, the press element 4, designed as a roll, may consist of several elements successive in the cross machine direction. The press element 4 may have its surface continuous or discontinuous. In addition, the press element 4 can be adapted to be movable for changing the processing zone length and/or belt tension. A metal belt may also becovered. In the embodiment shown in FIG. 1, the nip roll comprises a shoe roll. Reference numeral 6 represents heating elements, such as, for example, an induction heater, an infrared radiator, a gas burner, or a capacitive heater.

The use of a metal belt calender of the invention in an SC paper making method provides a runnability better than currently available solutions, by virtue of a supported web passage. The metal belt calender is capable of establishing an effective processing zone, which in trial runs has resulted in about 38% densification of paper while the maximum value reached by a /polymer nip is about 15%. An effective processing zone enables achievement of an equal quality of paper with fewer nips. Moreover, a metal belt calender is much more attractive than a supercalender in terms of costs.

The calendering of SC paper with a metal belt calender involves the use of one or more processing zones, preferably two. In a method of the invention, the calendering is performed preferably in two processes downstream of a dryer section, but a metal belt calender can be installed also at the dryer section, or both at and downstream of the dryer section. A metal belt calender installed at a dryer section can be possibly used as a replacement for a part of the dryer section or as a means to increase the speed of a paper machine. A metal belt calender included in a dryer section can also be used for the pre-calendering of SC paper.

The calendering of SC paper can be done by using temperatures of about 20-400° C., more preferably temperatures of about 150-200° C. A wide control range for temperature, along with a long application or action time, which may be within the range of 5-200 ms, and along with a wide control range for pressure, yields a high-quality calendering result both at high and low speeds, e.g. at speeds of 100 m/min to 4000 m/min.

The metal belt calender used in an SC paper calendering method of the invention can be provided with at least one press element disposed inside the belt for compressing the belt against a counter-element for enhancing a pressure pulse applied to a web passing through a processing zone. The press element 4 comprises preferably a roll, which is adapted to subject the metal belt to a linear load of about 0-400 kN/m, preferably about 30-100 kN/m. The press roll 4 may or may not be a deflection-compensated roll and is selected from a group, including: an elastic surface roll, such as a polymer-covered roll, a rubber-covered roll, or an elastomer surface roll, a shoe roll, a, a metal roll, a filled roll, and a composite roll.

The use of a metal belt calender of the invention in an LWC paper making method enables the treatment of a web on both sides in a single processing zone and provides a runnability better than solutions available today, by virtue of a supported web passage. In addition, the method provides a possibility of effectively adjusting one-sidedness by the application of temperature or moistening. The metal belt calender develops an effective processing zone, which in trial runs has been able to densify paper by about 38% while the highest value reached by a thermo roll/polymer roll nip is about 15%. The effective processing zone makes it possible to provide an equal quality of paper with a considerably lesser number of nips and a metal belt calender is much more attractive than multi-nip calenders in terms of price. In addition, a metal belt calender is capable of providing higher strengths than a machine calender.

The inventive LWC paper making method can be implemented by using temperatures of about 20-400° C., more preferably temperatures of about 150-200° C. A wide control range for temperature, along with a long application or action time, which may be within the range of 5-200 ms, and along with a wide control range for pressure, yields a high-quality calendering result both at high and low speeds, e.g. at speeds of 100 m/min to 4000 m/min. In the inventive method, the moisture of a paper web arriving at the calender is preferably within the range of 1-65%, preferably within the range of 8-15%.

The pre-calendering of LWC paper is preferably done by guiding a paper web between a thermo roll and a metal belt. In order to control one-sidedness, the metal belt may also lie against a soft roll. Pre-calendering is preferably performed in a single process. The metal belt and the thermo roll can both be heatable. In final calendering, the paper web is preferably guided between the soft surface roll and the metal belt. Final calendering can also be done in a nip between the thermo roll and thecovered metal belt. Preferably, the final calendering is performed in two processes. In order to achieve a uniform gloss and absorption of printing ink, the nip must be provided with a soft surface compliant with the fluctuation of a formation scale.

In a manufacturing method for mechanical-pulp containing, coated paper, the metal belt calender can also be installed at a dryer section, whereby it can be used to replace a part of the dryer section of a paper machine or to increase the speed of a paper machine. For example, by adjusting the temperature of a thermo roll functioning as a counter-element to the reading of 200° C. and its contact time with a metal belt to the reading of 40 ms, a single nip will be sufficient for drying the paper from 13% to 6%.

FIG. 2 discloses values for the PPS roughness of LWC paper after final calendering in association with various pre-calendering methods. FIG. 3 discloses values for the Bendtsen roughnesses of LWC paper after final calendering in association with various pre-calendering methods. The laboratory-scale test results shown in FIGS. 2 and 3 indicate that the inventive metal-belt precalendering is capable of providing desired smoothness properties, e.g. a high large-scale smoothness (a low Bendtsen roughness) is good as compared to a machine calender or a soft calender.

The use of an inventive metal belt calender in a method for making newsprint enables the treatment of a web on both sides in a single processing zone and provides a runnability better than solutions available today, by virtue of a supported web passage. In addition, the method provides a possibility of effectively adjusting one-sidedness by the application of temperature or moistening. The metal belt calender develops an effective processing zone, which in trial runs has been able to densify paper by about 38% while the highest value reached by a soft nip is about 15%. The effective processing zone makes it possible to provide improved newsprint with a metal belt calender, nor does it cause process-engineering related speed limitations. In addition, a metal belt calender is capable of providing higher strengths than a machine calender.

The inventive solution for making newsprint can be implemented by using temperatures of about 20-400° C., more preferably temperatures of about 150-200° C. A wide control range for temperature, along with a long application or action time, which may be within the range of 5-200 ms, and along with a wide control range for pressure, yields a high-quality calendering result both at high and low speeds, e.g. at speeds of 100 m/min to 4000 m/min. In the inventive method, the moisture of a paper web arriving at the calender is conveniently within the range of 1-65%, preferably within the range of 8-15%.

In a newsprint making method, as well, the metal belt calender can be installed at a dryer section, whereby it can be used to replace a part of the dryer section of a paper machine or to increase the speed of a paper machine. For example, by adjusting the temperature of a thermo roll functioning as a counter-element to the reading of 200° C. and its contact time with a metal belt to the reading of 40 ms, a single nip will be sufficient for drying the paper from 13% to 6%.

FIG. 4 illustrates values for PPS roughness in relation to the attained density in various process conditions, and FIG. 5 shows the relationship of Bendtsen roughnesses for paper used in the test in various process conditions, the pulp composition and basis weight of said paper being consistent with those of newsprint. The test results of FIGS. 4 and 5 indicate that the inventive metal-belt calendering is capable of providing desired smoothness properties, e.g. the Bendtsen roughness is low as compared to a machine calender or a soft calender.

The inventive method for making newsprint is applicable to the manufacture of both traditional newsprint made without surface sizing and to the manufacture of surface sized and/or pigmented newsprint. In the case of surface sizing and/or pigmentation, the metal belt calender is preferably located downstream of a surface sizing/coating station.

In a method of the invention for making coated, chemical-pulp containing fine paper (WFC), a contact time between a paper web and a metal belt is conveniently adjusted to the range of about 5-200 ms, more preferably to the range of about 20-80 ms, and the metal belt temperature is most conveniently adjusted to the range of about 20-400° C., more preferably to the range of about 150-200° C. The moisture of a paper web arriving at the calender is adjustable within the range of about 1-65%, preferably within the range of about 8-15%, depending on a contact time with a metal belt and temperatures applied in calendering. Moistening can be effected by means of an on-line moistener upstream of the metal belt calender. The counter-element for a metal belt comprises preferably a thermo roll or an elastic surface roll, such as a polymer-covered roll, a rubber-covered roll or an elastomer surface roll, a shoe roll, a composite roll, a metal roll, or a filled roll. In the case of a thermo roll, its temperature is adjusted conveniently to the range of about 20-400° C., more preferably to the range of about 150-200° C.

The metal belt calender used in a WFC making method of the invention can be provided with at least one press element disposed inside the belt for compressing the belt against a counter-element for enhancing a pressure pulse applied to a web passing through a processing zone. The press element comprises preferably a roll, which is adapted to subject the metal belt to a linear load of about 0-400 kN/m, preferably about 30-100 kN/m.

Performing the pre-calendering of coated fine paper according to the invention with a metal belt calender provides substantially better results than those obtained by prior art pre-calendering methods. For example, the distribution of coating is more uniform or consistent than what is achieved by a pre-calendering process performed with a currently available machine calender, and this results in a low mottling. In addition, the metal belt precalender is capable of providing a higher gloss and a lower roughness in a coated and finally calendered product. Moreover, the metal belt calender used in a method of the invention enables the treatment of both sides of a web in a single nip and provides a runnability better than that obtained by current solutions, by virtue of a supported web passage. Furthermore, the method enables effective adjustment of one-sidedness by the application of temperature or moistening. The metal belt calender develops an effective processing zone, which in trial runs has been able to densify paper by about 38% while the highest value reached by a soft nip is about 15%. When used for pre-calendering, the effective processing zone reduces the need for final calendering, nor does it cause process-engineering related speed constraints. In addition, a metal belt calender is capable of providing higher strengths than a machine calender. Another advantage of a metal belt calender is that, unlike a soft calender, it has no easily damaged coatings on rolls/belt.

In a method of the invention for making WFC, metal-belt precalendering is preferably combined with metal-belt final calendering, but the final calendering can also be performed with currently available off-line or on-line multi-roll calenders or on-line or off-line soft calenders, whereby the extent of final calendering can be reduced in these systems by virtue of metal-belt precalendering. In a method of the invention for making WFC, it is also possible to employ a prior art pre-calendering solution implemented by a machine calender or a soft calender and to perform the final calendering with a metal belt calender for advantages over e.g. a currently popular final calendering process effected by means of a multi-roll calender; e.g. providing an equal paper quality with a considerably lower number of nips, by virtue of an effective processing zone. In addition, a metal belt calender is much more attractive than a multi-roll calender in terms of costs.

The use of a metal belt calender offers also a drying potential, by virtue of which it can be used for replacing a part of the dryer section or for increasing the speed of a paper machine. For example, the use of a thermo roll as a counter-element and the adjustment of its temperature to the reading of 200° C. and its contact time with a metal belt to the reading of 40 ms enables drying the paper from 10% to 6% with just one nip.

The inventive solution for making WFC can be implemented by using temperatures of about 20-400° C., more preferably temperatures of about 150-200° C. A wide control range for temperature, along with a long application or action time, which may be within the range of 5-200 ms, and along with a wide control range for pressure, yields a high-quality calendering result both at high and low speeds, e.g. at speeds of 100 m/min to 4000 m/min. In the inventive method for making WFC, the moisture of a paper web arriving at the calender is conveniently within the range of 1-65%, preferably within the range of 8-15%.

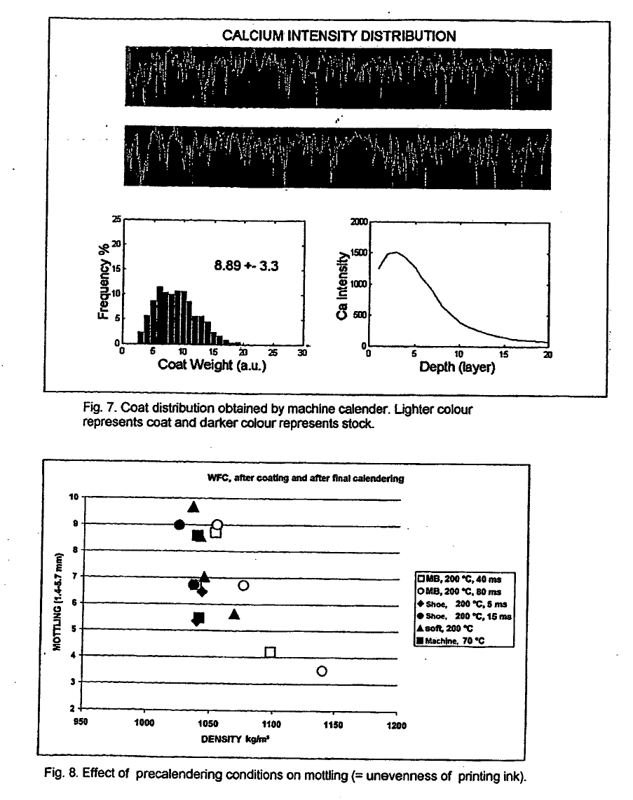

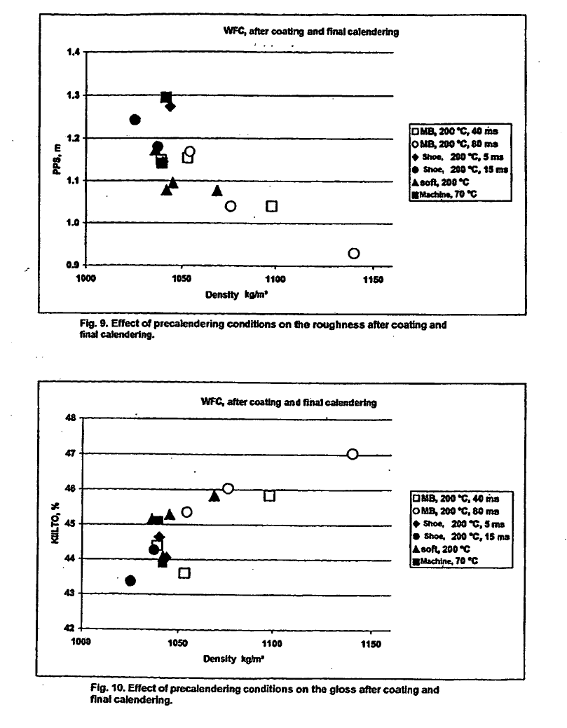

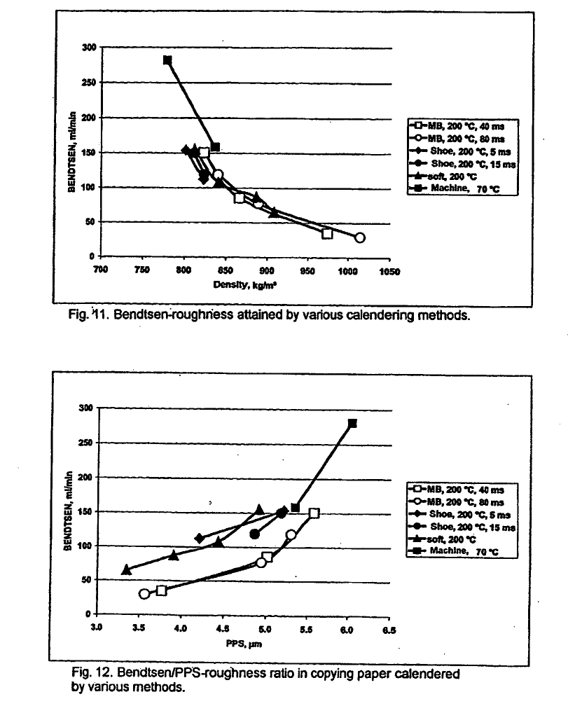

FIGS. 6-10 visualize the effect of metal-belt precalendering on final properties on the basis of trial run results. These figures indicate that the results are significantly improved over prior art methods. FIGS. 6 and 7 illustrate that the metal-belt precalendering has resulted in a more uniform distribution of coating than what is obtained by a currently used machine calendering method. By virtue of the even distribution, the mottling is low, as indicated in FIG. 8. FIGS. 9 and 10 reveal that the metal-belt precalendering has resulted in a higher gloss and a lower roughness in a coated and finally calendered product.

In final calendering for making WFC, the paper web is preferably passed in between a soft surface roll and a metal belt. Final calendering can also be performed in a nip between a thermo roll and acovered metal belt. Preferably, final calendering is carried out in two processes. In order to achieve a consistent gloss and absorption of printing ink, the nip must be provided with a soft surface adapting itself to the fluctuation of a formation scale. Matte finish grades can be made by means of an appropriately patterned belt or thermo roll.

In a method for making uncoated fine papers, the contact time between a paper web and a metal belt is conveniently adjusted to the range of about 5-200 ms, more preferably to the range of about 20-80 ms, and the metal belt temperature is most conveniently adjusted to the range of about 20-400° C., more preferably to the range of about 150-200° C. The moisture of a paper web arriving at the calender is adjustable within the range of about 1-65%, preferably within the range of about 8-15%, depending on a contact time with a metal belt and temperatures applied in calendering. Moistening can be effected by means of an on-line moistener upstream of a metal belt calender. The counter-element for a metal belt comprises preferably a thermo roll or an elastic surface roll, such as a polymer-covered roll, a rubber-covered roll, or an elastomer surface roll. When using a thermal toll, its temperature is conveniently adjusted to the range of about 20-400° C., more preferably to the range of about 150-200° C.

A metal belt calender used in a method of the invention for making uncoated fine papers can be provided with at least one press element disposed inside the belt to compress the belt against a counter-element for enhancing a pressure pulse applied to a web passing through a calendering zone. The press element comprises preferably a roll, which is adapted to apply against the metal belt a linear load of about 0-400 kN/m, preferably about 30-100 kN/m.

In a method of the invention for making uncoated fine papers, calendering is preferably performed as final calendering in a single process downstream of a dryer section, but the metal belt calender can be installed also at a dryer section or both at and downstream of a dryer section.

The inventive solution for making uncoated fine papers can be implemented by using temperatures of about 20-400° C., more preferably temperatures of about 150-200° C. A wide control range for temperature, along with a long application or action time, which may be within the range of 5-200 ms, and along with a wide control range for pressure, yields a high-quality calendering result both at high and low speeds, e.g. at speeds of 100 m/min to 4000 m/min. In the inventive method for making uncoated fine papers, the moisture of a paper web arriving at the calender is conveniently within the range of 1-65%, preferably within the range of 8-15%.

In a method of the invention for making uncoated fine papers, the metal belt calender can be installed at a dryer section, whereby it can be used to replace a part of the dryer section of a paper machine or to increase the speed of a paper machine. For example, by adjusting the temperature of a thermo roll functioning as a counter-element to the reading of 200° C. and its contact time with a metal belt to the reading of 40 ms, a single nip will be sufficient for drying the paper from 10% to 6%.

The use of a metal belt calender of the invention in a method for making uncoated fine papers enables the treatment of both sides of a web in a single nip and provides a runnability better than that obtained by current solutions, by virtue of a supported web passage. Furthermore, the method enables effective adjustment of one-sidedness by the application of temperature or moistening. The metal belt calender develops an effective processing zone, which in trial runs has enabled densification of paper by about 38% while the highest value reached by a soft nip is about 15%. The effective processing zone enables the production of colour copying paper smoother than standard copying paper with a metal belt calender, nor does it cause process-engineering related speed constraints. In addition, a metal belt calender is capable of providing higher strengths than a machine calender. Another advantage of a metal belt calender is that, unlike a soft calender, it has no easily damaged coatings on rolls/belt.

FIG. 11 illustrates Bendtsen roughness values obtained with WFU paper in relation to density attained with various calendering methods, and FIG. 12 shows the relationship between Bendtsen and PPs roughnesses in various calendering methods. Test results disclosed in FIGS. 11 and 12 indicate that the metal belt calendering of the invention is capable of yielding desired smoothness properties and provides a favourable ratio for Bendtsen/PPS roughnesses.

The inventive solution for making release paper can be implemented by using temperatures of about 20-400° C., more preferably temperatures of about 150-200° C. A wide control range for temperature, along with a long application or action time, which may be within the range of 5-200 ms, and along with a wide control range for pressure, yields a high-quality calendering result both at high and low speeds, e.g. at speeds of 100 m/min to 4000 m/min. In the inventive method, the moisture of a paper web arriving at the calender is conveniently within the range of 1-65%, preferably within the range of 8-15%.

In a method of the invention for making release paper, the metal belt calender can be installed at a dryer section, whereby it can be used to replace a part of the dryer section of a paper machine or to increase the speed of a paper machine. The metal belt calender can also be used for avoiding a separate drying process after the calendering process.

The use of a metal belt calender of the invention for making release paper provides a runnability better than currently available solutions, by virtue of a supported web passage. The metal belt calender is capable of establishing an effective processing zone, which in trial runs has resulted in about 38% densification of paper while the maximum value reached by a thermo roll/polymer nip is about 15%. An effective processing zone enables achievement of an equal quality of paper with fewer nips. Moreover, a metal belt calender is much more attractive than a supercalender in terms of costs.

The process of calendering release paper with a metal belt calender involves the use of one or more, preferably 2-4 processing zones. In a method of the invention, calendering is performed preferably as final calendering in a single process downstream of a dryer section, but the metal belt calender can also be located at a dryer section or both at and downstream of a dryer section.

In a method for making release paper, a contact time between a paper web and a metal belt is conveniently adjusted to the range of about 5-200 ms, more preferably to the range of about 20-80 ms, and the metal belt temperature is most conveniently adjusted to the range of about 20-400° C., more preferably to the range of about 150-200° C. The moisture of a paper web arriving at the calender is adjustable within the range of about 1-65%, preferably within the range of about 8-15%, depending on a contact time with a metal belt and temperatures applied in calendering. Moistening can be effected by means of an on-line moistener upstream of the metal belt calender.

The counter-element for a metal belt comprises preferably a thermo roll or an elastic surface roll, such as a polymer-covered roll, a rubber-covered roll or an elastomer surface roll. In another conceivable solution, release paper can be calendered between a thermo roll and acovered metal belt. When using a thermo roll, its temperature is adjusted conveniently to the range of about 20-400° C., more preferably to the range of about 150-200° C.

A metal belt calender used in a release paper making method of the invention can be provided with at least one press element disposed inside the belt for compressing the belt against a counter-element for enhancing a pressure pulse applied to a web passing through a processing zone. The press element 4 comprises preferably a roll, which is adapted to subject the metal belt to a linear load of about 0-500 kN/m, preferably about 30-100 kN/m. The press roll 4 may or may not be a deflection-compensated roll and is selected from a group, including: an elastic surface roll, such as a polymer-covered roll, a rubber-covered roll or an elastomer surface roll, a shoe roll, a thermo roll, a metal roll, a filled roll, and a composite roll.

The inventive solution for making a coated board product can be implemented, especially when using a metal belt, by applying elevated temperatures, for example within the range of more than about 100° C. to more than about 200° C., and even up to about 400° C., depending on intended application. The elevated temperature, along with a long action time and a wide pressure control range, yields a high-quality calendering result both at high and low speeds, e.g. at speeds of 100 m/min to 4000 m/min. The web dwell time in a calendering zone can be adjusted to lie within the range of 0-1000 ms, preferably within the range of 60-200 ms. A metal belt calender enables a supported passage for the web through the calendering zone and allows for a controlled fluctuation of the web width within the limits defined by the belt width. Web feeding is feasible over the full web width and at a high web speed. Web feeding is performed in a per se known manner, e.g. by means of a cord.

Moisture regulation in a to-be-conditioned web can be effected by conventional means, for example by steaming the web surface/surfaces prior to feeding the web into a processing zone. Moistening and/or the adjustment of temperature can be used for applying a desired effect on the lateral profile of a web and the method provides a possibility of varying the web moisture over a wide range.

The inventive board making method may also involve a process of cooling a metal belt or a thermo roll to a temperature of about −70° C. to +50° C., e.g. for providing condensation.

A metal belt calender can be operated at remarkably high speeds, and by additionally using an elevated temperature, e.g. about 250° C., and by taking into account a long dwell time in the processing zone, preferably in the order of 60-200 ms, it is possible to provide a glazing action equal to what is achieved in a slower solution implemented with a Yankee cylinder. In addition, the board can be provided with improved bulk, which in turn, along with conserved energy and raw material, results in savings of natural resources as compared to the use of a Yankee cylinder. Another advantage gained by the inventive solution is a relatively low power demand, since the transmission of energy, heat, and power to a web takes place in a single process in an intensified fashion. The heat introduced into a web or a coating layer is not able to escape from the web to ambient atmosphere but, instead, continues on its part to increase the web temperature, thus making the glazing of a web surface essentially easier.

In conducted test runs, the inventive board (a pre-calendered, coated board product) maintained a stability of bulk better than prior known boards and, at the same time, the surface properties improved with respect to prior known and generally manufactured surface-treated boards. From the manufacturer's perspective, the same stiffness was obtained with a considerably smaller amount of material, the difference from a board made from the same pulp in the same board machine being presented in table 3:

TABLE 3

| | | PPS | Hunter | Bendtsen |
|---|---|---|---|---|
| | Density | roughness | gloss | roughness |
| Pretreatment | kg/m³ | μm | % | ml/min |
| Yankee cylinder + | 661 | 1.91 | 30.3 | 14 |
| machine calender | | | | |
| MB-calender | 619 | 1.77 | 31.5 | 13 |

Thus, the test run managed a bulk saving of more than 6% as compared to the use of a Yankee cylinder. The surface was also smoother. Hence, the resulting saving in bulk translates to improved stiffness with the same consumption of material, which means that, in practice, the board manufacturer saves a corresponding amount of material. Based on experience, the interpretation of test results indeed indicates a major advancement, for example, in terms of boxboard quality and production economy. Generally, the results obtained in off-line tests are poorer than those achieved in the final environment, so even on the basis of these preliminary tests, it is possible to conclude that the method is capable of producing board which has not been managed before. Moreover, the method is applicable to substantially higher speeds than a Yankee cylinder.

According to FIG. 13, the surface of a belt 2 is provided with impressions complementary to desired patterns or embossments. A material web W to be calendered advances through a calendering zone, being subjected to a desired pressure impulse and thermal effect as a function of time and the fibrous web being calendered with the exception of sections or regions which coincide with impressions 136 arranged in the belt 2 and complementary to the shapes of desired embossments. The impressions 136 can also be dimensioned in such a way that the section of a web, coinciding therewith, will be calendered, but to a lesser extent than the web region surrounding this particular section, whereby the web develops a less calendered area distinctive from its surrounding region and consistent with the impressions 136.

FIG. 13 illustrates the belt calender of FIG. 1 obliquely from the side in a larger scale for unveiling uncalendered or less calendered regions 137 formed on the fibrous web W and complementary to the impressions 136 provided on the belt 2. It is also conceivable that the impressions 136, provided in FIG. 13 only on the belt 2 and complementary to the shapes of desired embossments, be provided in desired shapes also on the surface of a roll 5 functioning as a counter-element, whereby the uncalendered or less calendered regions 137 develop on both sides of the to-be-calendered fibrous web W. In FIG. 13, both the fibrous web W, the belt 2 and the regions 137 have the thicknesses or thickness differences thereof exaggerated, and likewise the impressions 136 included in the belt 2 have the depth thereof exaggerated, and furthermore, the fibrous web W and the belt 2 have the passages thereof diverged for the sake of improved clarity.

The method is particularly suitable for a metal belt calender, yet it is highly applicable also to other calender types, such as a soft calender, a machine calender, a shoe calender or, for example, a multi-nip calender. The production of safety paper is most preferably carried out in the final calendering process of a paper machine, whereby the surface of uncalendered or less calendered regions remains essentially unchanged in subsequent processes.

It is also conceivable that safety paper be produced at a later stage downstream of a fibrous web cutting and packing operation, i.e. the final calendering of a fibrous web is omitted from the actual paper machine and is performed later, in the case of board used for product packages, for example, in connection with printing which precedes the cutting of packages, the production of safety paper being thus flexible in small batches according to special requirements.

Generally, it can be concluded that a processing device of the invention provides a very high efficiency in calendering and/or other treatment in a single process. Another way of exploiting this to combine a processing device of the invention with a second calender for increased calendering capacity. Such a second calender may comprise e.g. a supercalender or a multi-roll calender, e.g. a multi-roll calender manufactured by the Applicant under the name OptiLoad, or e.g. a soft calender or a long-nip calender. For example, the production of SC and LWC paper grades involves typically the use of 10- to 12-roll super- or multi-roll calenders. Modern paper machines, running at the speed of 1800-2000 m/min, require even up to 4 supercalenders or multi-roll calenders per paper machine. Typically, 2 or 3 off-line calenders are sufficient for handling the production of a single paper machine. Calendering speeds vary within the range of 500-700 m/min. Nip pressures are typically 300-400 kN/m and the thermo roll surface temperature within the range of 80-120° C. The two-sidedness of paper can be controlled by means of a reversed positioning for the top and bottom nips of a calender, by varying temperatures or steaming levels. SC-C and SC-B grades, which are intermediates between newsprint and smooth SC papers, can be produced also with two-nipped soft calenders. The surface temperature in running is 160-200° C. and nip pressures are up to 350 kN/m. Steaming is also an essential operation in the calendering of these grades.

In the process of combining a metal belt calender of the invention e.g. with the OptiLoad calender, the metal belt calender will be preferably located immediately before the first nip or after the last nip of the OptiLoad calender. It is also conceivable that a metal belt calender be located between the stacks of a two-stack calender. A metal belt calender can also be located upstream of a single- or two-nipped soft calender for raising the performance of this particular soft calender. The purpose of metal belt calendering is to compact and heat a to-be-treated fibrous web upstream of a multi-nip calender or a soft calender or downstream thereof or possibly also at the intermediate stage (e.g. between the stacks of a two-stack calender). The enhancement of a calendering process can be used for attaining running speeds higher than at present.

The inventive device allows for very extensive ranges for pressures, temperatures and dwell times, a variety of combinations thereof being conceivable depending on intended application. For example, the pressure domain can be within the range of about 0.01 MPa to about 70 MPa or even up to the reading of 200 MPa, temperature can be within the range of about −70° C. to about +400° C., and dwell time in a processing zone e.g. within the range of about 0.01 ms to about 2 s, or even in the order of 10 s. In addition, various machine speeds can be used for producing various grades. The inventive device may comprise an on-line or off-line device.

In various methods using a processing device of the invention, it is also preferably possible to cool a metal belt or a thermo roll to a temperature of about −70° C. to +50° C., e.g. for providing condensation. The cooling of a metal belt can be provided for example by a heat transfer to a cooling liquid, an evaporation surface, a cooling roll or belt.

1. A processing device for processing a coated or uncoated fibrous web, said device comprising a belt (2) adapted to extend around at least one guiding element (3), at least one counter-element (5) being disposed outside said belt to provide a contact area with the belt, such that the belt (2) and the counter-element (5) establish therebetween a web processing zone for passing a web to be processed therethrough, characterized in that the processing zone length is defined by means of the disposition/adjustment of the belt's (2) guiding element (3) and/or by means of the design of the counter-elements (5), and that a contact pressure applied to a web in the processing zone is adapted to be adjustable within the range of about 0.01 MPa to about 200 MPa.

2. A method of making SC paper, in which method a paper web coming from the press section of a paper machine is passed through at least one calendering process, characterized in that the method uses in said at least one calendering process the processing device (1) as set forth in claim 1, comprising a metal belt (2) adapted to extend around at least one guiding element (3), at least one counter-element (5) being disposed outside said belt to provide a contact area with the belt, such that the belt (2) and the counter-element (5) establish therebetween a web processing zone for passing a web to be processed therethrough, the processing zone length in said processing device being defined by means of the disposition/adjustment of the belt's (2) guiding element (3) and/or the design of the counter-elements (5), and that a contact pressure applied to the web in the processing zone is adjusted to lie within the range of about 0.01 MPa to about 70 MPa.

3. A method as set forth in claim 2, characterized in that the contact time of a paper web with a metal belt is adjusted to the range of about 5-200 ms.

4. A method as set forth in claim 3, characterized in that the contact time of a paper web with a metal belt is adjusted to the range of about 20-80 ms.

5. A method as set forth in any of claims 2-4, characterized in that the temperature of a metal belt is adjusted to the range of about 20-400° C.

6. A method as set forth in claim 5, characterized in that the temperature of a metal belt is adjusted to the range of about 150-200° C.

7. A method as set forth in any of claims 2-6, characterized in that the method uses acovered metal belt, the counter-element (5) of which comprises a thermo roll having its temperature adjusted to the range of about 20-400° C.

8. A method as set forth in claim 7, characterized in that the temperature of a thermo roll is adjusted to the range of about 150-200° C.

9. A method as set forth in any of claims 2-6, characterized in that the counter-element (5) used in the method comprises at least one roll, which may or may not be a deflection-compensated roll and which is selected from a group, including: an elastic surface roll, such as a polymer-covered roll, a rubber-covered roll or an elastomer surface roll, a shoe roll, a thermo roll, a metal roll, a filled roll, and a composite roll.

10. A method as set forth in any of claims 2-8, characterized in that the method uses at least one press element (4), disposed inside the belt (2), for compressing the belt (2) against the counter-element (5) for enhancing a pressure pulse applied to a web passing through a processing zone.

11. A method as set forth in claim 10, characterized in that the press element comprises at least one roll (4), which may or may not be a deflection-compensated roll and which roll is selected from a group, including: an elastic surface roll, such as a polymer-covered roll, a rubber-covered roll or an elastomer surface roll, a shoe roll, a thermo roll, a metal roll, a filled roll, and a composite roll.

12. A method as set forth in claim 11, characterized in that the roll (4) applies against a metal belt a linear load of about 0-400 kN/m.

13. A method as set forth in claim 12, characterized in that the linear load is about 30-100 kN/m.

14. A method as set forth in any of claims 2-13, characterized in that the method uses two or more calendering processes.

15. SC paper produced with a method as set forth in claim 2, characterized in that the surface has a PPS s10 roughness (SCAN-P 76:95) of 0.6-3 μm and/or a density (SCAN-P7:75) of 600-1400 kg/m³.

16. SC paper as set forth in claim 15, characterized in that the paper comprises mechanical pulp to 50-75% and/or chemical pulp to 5-25% and/or a filler and/or recycled pulp (DIP) to 10-35%.

17. SC paper as set forth in claim 15, characterized in that the PPS s10 roughness (SCAN-P 76:95) is 1.0-2.5 μm.

18. SC paper as set forth in claim 15, characterized in that the density (SCAN-P7:75) is 700-1250 kg/m³.

19. A method of making mechanical-pulp containing coated paper, in which method a paper web coming from the press section of a paper machine is passed through at least one pre-calendering process upstream of a coating station and/or through at least one final calendering process downstream of a coating station, characterized in that the method uses in the pre-calendering process and/or in the final calendering process the processing device (1) as set forth in claim 1, comprising a metal belt (2) adapted to extend around a guiding element (3), at least one counter-element (5) being disposed outside said belt to provide a contact area with the belt, such that the belt (2) and the counter-element (5) establish therebetween a web processing zone for passing a web to be processed therethrough, the processing zone length in said processing device being defined by means of the disposition/adjustment of the belt's (2) guiding element (3) and/or the design of the counter-elements (5), and that a contact pressure applied to the web in the processing zone is adjusted to lie within the range of about 0.01 MPa to about 70 MPa.

20. A method as set forth in claim 19, characterized in that the contact time of a paper web with a metal belt is adjusted to the range of about 5-200 ms.

21. A method as set forth in claim 20, characterized in that the contact time of a paper web with a metal belt is adjusted to the range of about 20-40 ms.

22. A method as set forth in any of claims 19-21, characterized in that the temperature of a metal belt is adjusted to the range of about 20-400° C.

23. A method as set forth in claim 22, characterized in that the temperature of a metal belt is adjusted to the range of about 150-200° C.

24. A method as set forth in any of the preceding claims, characterized in that the counter-element (5) used in the method comprises a thermo roll, having its temperature adjusted to the range of about 20-400° C.

25. A method as set forth in claim 24, characterized in that the temperature of a thermo roll is adjusted to the range of about 150-200° C.

26. A method as set forth in any of claims 19-25, characterized in that the counter-element (5) used in the method comprises at least one roll, which may or may not be a deflection-compensated roll and is selected from a group, including: an elastic surface roll, such as a polymer-covered roll, a rubber-covered roll or an elastomer surface roll, a shoe roll, a thermo roll, a metal roll, a filled roll, and a composite roll.

27. A method as set forth in any of claims 19-26, characterized in that the method comprises the use of at least one press element (4) disposed inside the belt (2) for compressing the belt (2) against the counter-element (5) for enhancing a pressure pulse applied to a web passing through a processing zone.

28. A method as set forth in claim 27, characterized in that the press element (4) comprises at least one roll, which may or may not be deflection-compensated and is selected from a group, including: an elastic surface roll, such as a polymer-covered roll, a rubber-covered roll or an elastomer surface roll, a shoe roll, a thermo roll, a metal roll, a filled roll, and a composite roll.

29. A method as set forth in claim 28, characterized in that the roll (4) applies against a metal belt a linear load of about 0-400 kN/m.

30. A method as set forth in claim 29, characterized in that the linear load is about 30-100 kN/m.

31. A method as set forth in any of claims 19-30, characterized in that both pre-calendering and final calendering are performed by means of the metal belt calender (1).

32. A method as set forth in any of claims 19-31, characterized in that pre-calendering is performed-by means of the metal belt calender (1) and final calendering by means of an off-line or on-line multi-roll calender.

33. A method as set forth in any of claims 19-32, characterized in that pre-calendering is performed by means of the metal belt calender (1) and final calendering by means of an on-line or off-line soft calender.

34. A method as set forth in any of claims 19-32, characterized in that pre-calendering is performed by means of a machine calender, a soft calender or a shoe calender and final calendering by means of the metal belt calender (1).

35. A method as set forth in any of claims 19-32, characterized in that pre-calendering is performed by means of the metal belt calender (1) and final calendering by means of a shoe calender or a multi-roll calender.

36. Mechanical-pulp containing coated paper produced with a method as set forth in claim 19, characterized in that the surface has a PPS s10 roughness (SCAN-P 76:95) of 0.4-5.0 μm and/or a Bendtsen roughness (SCAN-P21:67) of 0.1-300 ml/min and/or a density (SCAN-P7:75) of 600-1500 kg/m³.

37. Mechanical-pulp containing coated paper as set forth in claim 36, characterized in that the surface has a PPS s10 roughness (SCAN-P 76:95) of 0.6-2.8 μm.

38. Mechanical-pulp containing coated paper as set forth in claim 36, characterized in that the surface has a Bendtsen roughness (SCAN-P21:67) of 5-100 ml/min.

39. Mechanical-pulp containing coated paper as set forth in any of claims 36-38, characterized in that the product comprises MFC (machine finished coated).

40. Mechanical-pulp containing coated paper as set forth in any of claims 36-38, characterized in that the product comprises FCO (film coated offset).

41. Mechanical-pulp containing coated paper as set forth in any of claims 36-38, characterized in that the product comprises LWC (light weight coated).

42. Mechanical-pulp containing coated paper as set forth in any of claims 36-38, characterized in that the product comprises MWC (medium weight coated).

43. Mechanical-pulp containing coated paper as set forth in any of claims 36-38, characterized in that the product comprises HWC (heavy weight coated).

44. Mechanical-pulp containing coated paper as set forth in any of claims 36-38, characterized in that the product is coated at least once prior to pre-calendering and/or final calendering.

45. A method of making newsprint, in which method a paper web coming from the press section of a paper machine is passed through at least one calendering process, characterized in that the method uses in said at least one calendering process the processing device (1) as set forth in claim 1, comprising a metal belt (2) adapted to extend around a guiding element (3), at least one counter-element (5) being disposed outside said belt to provide a contact area with the belt, such that the belt (2) and the counter-element (5) establish therebetween a web processing zone for passing a web to be processed therethrough, the processing zone length in said processing device being defined by means of the disposition/adjustment of the belt's (2) guiding element (3) and/or the design of the counter-elements (5), and that a contact pressure applied to the web in the processing zone is adjusted to lie within the range of about 0.01 MPa to about 70 MPa.

46. A method as set forth in claim 45, characterized in that the contact time of a paper web with a metal belt is adjusted to the range of about 5-200 ms.

47. A method as set forth in claim 46, characterized in that the contact time of a paper web with a metal belt is adjusted to the range of about 20-40 ms.

48. A method as set forth in any of claims 45-47, characterized in that the temperature of a metal belt is adjusted to the range of about 20-400° C.

49. A method as set forth in claim 48, characterized in that the temperature of a metal belt is adjusted to the range of about 150-200° C.

50. A method as set forth in any of claims 45-49, characterized in that the counter-element (5) used in the method comprises a thermo roll, having its temperature adjusted to the range of about 20-400° C.

51. A method as set forth in claim 50, characterized in that the temperature of a thermo roll is adjusted to the range of about 150-200° C.

52. A method as set forth in any of claims 45-49, characterized in that the counter-element (5) used in the method comprises at least one roll, which may or may not be a deflection-compensated roll and is selected from a group, including: an elastic surface roll, such as a polymer-covered roll, a rubber-covered roll or an elastomer surface roll, a shoe roll, a thermo roll, a metal roll, a filled roll, and a composite roll.

53. A method as set forth in any of claims 45-52, characterized in that the method comprises the use of at least one press element (4) disposed inside the belt (2) for compressing the belt (2) against the counter-element (5) for enhancing a pressure pulse applied to a web passing through a processing zone.

54. A method as set forth in claim 53, characterized in that the press element comprises at least one roll (4), which may or may not be deflection-compensated and which roll is selected from a group, including: an elastic surface roll, such as a polymer-covered roll, a rubber-covered roll or an elastomer surface roll, a shoe roll, a thermo roll, a metal roll, a filled roll, and a composite roll.

55. A method as set forth in claim 54, characterized in that the roll (4) applies against a metal belt a linear load of about 0-400 kN/m.

56. A method as set forth in claim 55, characterized in that the linear load is about 30-100 kN/m.

57. Newsprint produced with a method as set forth in claim 45, characterized in that the surface has a PPS s10 roughness (SCAN-P 76:95) of 2.5-7.0 μm and/or a Bendtsen roughness (SCAN-P21:67) of 30-600 ml/min.

58. Newsprint as set forth in claim 57, characterized in that the surface has a PPS s10 roughness (SCAN-P 76:95) of 3.5-5.0 μm.

59. Newsprint as set forth in claim 57, characterized in that the surface has a Bendtsen roughness (SCAN-P21:67) of 40-200 ml/min.

60. A method of making coated, chemical-pulp based fine paper (WFC), in which method a paper web coming from the press section of a paper machine is passed through at least one pre-calendering process upstream of a coating station and through at least one final calendering process downstream of a coating station, characterized in that the method uses in the pre-calendering process and/or in the final calendering process the processing device (1) as set forth in claim 1, comprising a metal belt (2) adapted to extend around a guiding element (3), at least one counter-element (5) being disposed outside said belt to provide a contact area with the belt, such that the belt (2) and the counter-element (5) establish therebetween a web processing zone for passing a web to be processed therethrough, the processing zone length in said processing device being defined by means of the disposition/adjustment of the belt's (2) guiding element (3) and/or the design of the counter-elements (5), and that a contact pressure applied to the web in the processing zone is adjusted to lie within the range of about 0.01 MPa to about 70 MPa.

61. A method as set forth in claim 60, characterized in that the contact time of a paper web with a metal belt is adjusted to the range of about 5-200 ms.

62. A method as set forth in claim 61, characterized in that the contact time of a paper web with a metal belt is adjusted to the range of about 20-40 ms.

63. A method as set forth in any of claims 60-62, characterized in that the temperature of a metal belt is adjusted to the range of about 20-400° C.

64. A method as set forth in claim 63, characterized in that the temperature of a metal belt is adjusted to the range of about 150-200° C.

65. A method as set forth in any of claims 60-64, characterized in that the counter-element (5) used in the method comprises a thermo roll, having its temperature adjusted to the range of about 20-400° C.

66. A method as set forth in claim 65, characterized in that the temperature of a thermo roll is adjusted to the range of about 150-200° C.

67. A method as set forth in any of claims 60-64, characterized in that the counter-element (5) used in the method comprises at least one roll, which may or may not be a deflection-compensated roll and is selected from a group, including: an elastic surface roll, such as a polymer-covered roll, a rubber-covered roll or an elastomer surface roll, a shoe roll, a thermo roll, a metal roll, a filled roll, and a composite roll.

68. A method as set forth in any of claims 60-67, characterized in that the method comprises the use of at least one press element (4) disposed inside the belt (2) for compressing the belt (2) against the counter-element (5) for enhancing a pressure pulse applied to a web passing through a processing zone.

69. A method as set forth in claim 68, characterized in that said press element comprises at least one roll (4), which may or may not be deflection-compensated and which roll is selected from a group, including: an elastic surface roll, such as a polymer-covered roll, a rubber-covered roll or an elastomer surface roll, a shoe roll, a thermo roll, a metal roll, a filled roll, and a composite roll.

70. A method as set forth in claim 69, characterized in that said at least one roll (4), used as a press element, applies against a metal belt a linear load of about 0-400 kN/m.

71. A method as set forth in claim 70, characterized in that the linear load is about 30-100 kN/m.

72. A method as set forth in any of claims 60-71, characterized in that both pre-calendering and final calendering are performed by means of the metal belt calender (1).

73. A method as set forth in any of claims 60-71, characterized in that pre-calendering is performed by means of the metal belt calender (1) and final calendering by means of an off-line multi-roll calender.

74. A method as set forth in any of claims 60-71, characterized in that pre-calendering is performed by means of the metal belt calender (1) and final calendering by means of an on-line soft calender.

75. A method as set forth in any of claims 60-71, characterized in that pre-calendering is performed by means of a machine calender, a soft calender or a shoe calender and final calendering by means of the metal belt calender (1).

76. A method as set forth in any of claims 60-71, characterized in that pre-calendering is performed by means of the metal belt calender (1) and final calendering by means of a shoe calender or a multi-roll calender.

77. Coated, chemical-pulp based printing paper (WFC) produced with a method as set forth in claim 60, characterized in that the surface has a PPS s10 roughness (SCAN-P 76:95) of 0.4-3.0 μm and/or the gloss (ISO/DIS 8254) is 40-90%.

78. Coated, chemical-pulp based printing paper (WFC) as set forth in claim 77, characterized in that the surface has a PPS s10 roughness (SCAN-P 76:95) of 0.6-1.5 μm.

79. Coated, chemical-pulp based printing paper (WFC) as set forth in claim 77, characterized in that the gloss (ISO/DIS 8254) is 60-80%.

80. Coated, chemical-pulp based printing paper (WFC) as set forth in any of claims 77-79, characterized in that it comprises printing paper coated at least once.

81. Coated, chemical-pulp based printing paper (WFC) as set forth in any of claims 77-79, characterized in that it comprises printing paper coated on both sides at least once.

82. A method of making uncoated, chemical-pulp based fine paper (WFU), characterized in that a paper web coming from the press section of a paper machine is in the method passed to a processing device as set forth in claim 1, located at a dryer section and/or downstream of a dryer section and/or web surface sizing and comprising a metal belt (2) adapted to extend around a guiding element (3), at least one counter-element (5) being disposed outside said belt to provide a contact area with the belt, such that the belt (2) and the counter-element (5) establish therebetween a web processing zone for passing a web to be processed therethrough, the processing zone length in said processing device being defined by means of the disposition/adjustment of the belt's (2) guiding element (3) and/or the design of the counter-elements (5), and that a contact pressure applied to the web in the processing zone is adjusted to lie within the range of about 0.01 MPa to about 70 MPa.

83. A method as set forth in claim 82, characterized in that the contact time of a paper web with a metal belt is adjusted to the range of about 5-200 ms.

84. A method as set forth in claim 83, characterized in that the contact time of a paper web with a metal belt is adjusted to the range of about 20-40 ms.

85. A method as set forth in any of claims 82-84, characterized in that the temperature of a metal belt is adjusted to the range of about 20-400° C.

86. A method as set forth in claim 85, characterized in that the temperature of a metal belt is adjusted to the range of about 150-200° C.

87. A method as set forth in any of claims 82-86, characterized in that the counter-element (5) used in the method comprises a thermo roll, having its temperature adjusted to the range of about 20-400° C.

88. A method as set forth in claim 87, characterized in that the temperature of a thermo roll is adjusted to the range of about 150-200° C.

89. A method as set forth in any of claims 82-86, characterized in that the counter-element (5) used in the method comprises at least one roll, which may or may not be a deflection-compensated roll and is selected from a group, including: an elastic surface roll, such as a polymer-covered roll, a rubber-covered roll or an elastomer surface roll, a shoe roll, a thermo roll, a metal roll, a filled roll, and a composite roll.

90. A method as set forth in any of claims 82-89, characterized in that the method comprises the use of at least one press element (4) disposed inside the belt (2) for compressing the belt (2) against the counter-element (5) for enhancing a pressure effect applied to a web passing through a processing zone.

91. A method as set forth in claim 90, characterized in that the press element comprises at least one roll (4), which may or may not be deflection-compensated and which roll is selected from a group, including: an elastic surface roll, such as a polymer-covered roll, a rubber-covered roll or an elastomer surface roll, a shoe roll, a thermo roll, a metal roll, a filled roll, and a composite roll.

92. A method as set forth in claim 91, characterized in that said at least one roll (4), used as a press element, applies against a metal belt a linear load of about 0-400 kN/m.

93. A method as set forth in claim 92, characterized in that the linear load is about 30-100 kN/m.

94. A method as set forth in any of claims 82-93, characterized in that calendering is performed as final calendering in a single process.

95. Uncoated, chemical-pulp based fine paper (WFU) produced with a method as set forth in claim 82, characterized in that the surface has a PPS s10 roughness (SCAN-P 76:95) of 1.0-7.0 μm and/or a Bendtsen roughness (SCAN-P21:67) of 10-800 ml(min.

96. Uncoated, chemical-pulp based fine paper (WFU) as set forth in claim 95, characterized in that the surface has a PPS s10 roughness (SCAN-P 76:95) of 3.5-5.0 μm.

97. Uncoated, chemical-pulp based fine paper (WFU) as set forth in claim 95, characterized in that the Bendtsen roughness (SCAN-P21:67) is 50-200 ml/min.

98. Uncoated, chemical-pulp based fine paper (WFU) as set forth in any of claims 95-97, characterized in that the product comprises copying paper or colour copying paper

99. A method of making release paper, in which method a paper web coming from the press section of a paper machine is passed through at least one calendering process, characterized in that the calender used in the method in said at least one calendering process comprises the processing device (1) as set forth in claim 1, comprising a metal belt (2) adapted to extend around a guiding element (3), at least one counter-element (5) being disposed outside said belt to provide a contact area with the belt, such that the belt (2) and the counter-element (5) establish therebetween a web processing zone for passing a web to be processed therethrough, the processing zone length in said processing device being defined by means of the disposition/adjustment of the belt's (2) guiding element (3) and/or the design of the counter-elements (5), and that a contact pressure applied to the web in the processing zone is adjusted to lie within the range of about 0.01 MPa to about 200 MPa.

100. A method as set forth in claim 99, characterized in that the contact time of a paper web with a metal belt and counter-elements is adjusted to the range of about 5-200 ms.

101. A method as set forth in claim 100, characterized in that the contact time of a paper web with a metal belt and counter-elements is adjusted to the range of about 20-40 ms.

102. A method as set forth in any of claims 99-101, characterized in that the temperature of a metal belt is adjusted to the range of about 20-400° C.

103. A method as set forth in claim 102, characterized in that the temperature of a metal belt is adjusted to the range of about 150-200° C.

104. A method as set forth in any of the preceding claims, characterized in that the method uses a coated or uncoated metal belt, the counter-element (5) of which comprises a thermo roll, having its temperature adjusted to the range of about 20-400° C.

105. A method as set forth in claim 104, characterized in that the temperature of a thermo roll is adjusted to the range of about 150-200° C.

106. A method as set forth in any of claims 99-105, characterized in that the counter-element (5) used in the method comprises at least one roll, which may or may not be a deflection-compensated roll and is selected from a group, including: an elastic surface roll, such as a polymer-covered roll, a rubber-covered roll or an elastomer surface roll, a shoe roll, a thermo roll, a metal roll, a filled roll, and a composite roll.

107. A method as set forth in any of claims 99-106, characterized in that the method comprises the use of at least one press element (4) disposed inside the belt (2) for compressing the belt (2) against the counter-element (5) for enhancing a pressure effect applied to a web passing through a processing zone.

108. A method as set forth in claim 107, characterized in that the press element comprises at least one roll (4), which may or may not be deflection-compensated and which roll is selected from a group, including: an elastic surface roll, such as a polymer-covered roll, a rubber-covered roll or an elastomer surface roll, a shoe roll, a thermo roll, a metal roll, a filled roll, and a composite roll.

109. A method as set forth in claim 108, characterized in that the roll (4) applies against a metal belt a linear load of about 0-500 kN/m.

110. A method as set forth in claim 109, characterized in that the linear load is about 100-300 kN/m.

111. A method as set forth in any of claims 99-110, characterized in that the method comprises the use of one or more calendering processes.

112. A method as set forth in claim 111, characterized in that the number of treating processes is 2-4.

113. Release paper produced with a method as set forth in claim 99, characterized in that the release paper has a basis weight of 40-100 g/m² (SCAN-P 6:75) and/or a density of 800-1400 kg/m³ (SCAN-P7:75).

114. Release paper as set forth in claim 113, characterized in that the release paper has a basis weight of 60-90 g/m² (SCAN-P 6:75).

115. Release paper as set forth in claim 113, characterized in that the release paper has a density of 1000-1260 kg/m³ (SCAN-P7:75).

116. A coated board product, comprising two or more fiber layers and having its surface layers consisting of bleached chemical pulp and its middle layers of mechanical pulp, broke and/or recycled pulp, and said board having a basis weight of 100-700 g/m², characterized in that the product is fabricated by using a processing device as set forth in claim 1, comprising a metal belt (2) adapted to extend around a guiding element (3), at least one counter-element (5) being disposed outside said belt to provide a contact area with the belt, such that the belt (2) and the counter-element (5) establish therebetween a web processing zone for passing a web to be processed therethrough, the processing zone length in said processing device being defined by means of the disposition/adjustment of the belt's (2) guiding element (3) and/or the design of the counter-elements (5), that a contact pressure applied to the web in the processing zone is adjusted to lie within the range of about 0.01 MPa to about 70 MPa, that the web dwell time in the processing zone is within the range of about 0-1000 ms, and that said processing zone is located upstream of and/or as part of a coating station.

117. A board product as set forth in claim 116, characterized in that the surface properties on the topliner of the board are as follows:

| | | |
|---|---|---|
| PPSs10 roughness | 0.5-2.0 | μm |
| Hunter gloss (ISO/DIS8254) | 30-80% | |
| density (SCAN-P7:75) | 500-1000 | kg/m³. |

118. A board product as set forth in claim 117, characterized in that the middle board layer contains groundwood (GW), broke and/or recycled pulp.

119. A board product as set forth in claim 117, characterized in that the middle board layer contains pressure groundwood (PGW) and/or broke.

120. A board product as set forth in any of claims 116-119, characterized in that the topliner is coated once or several times.

121. A board product as set forth in any of claims 116-120, characterized in that the bottom layer is uncoated.

122. A board product as set forth in any of claims 116-120, characterized in that the bottom layer is coated at least once.

123. A board product as set forth in any of claims 116-120, characterized in that the basis weight is within the range of 180-350 g/m².

124. A board product as set forth in any of claims 116-120, characterized in that the basis weight is within the range of 180-300 g/m².

125. A board product as set forth in any of claims 116-124, characterized in that the topliner has a Bendtsen roughness (SCAN-P21:67) of 0-50 ml/min.

126. A board product as set forth in any of claims 116-124, characterized in that the topliner has a Bendtsen roughness (SCAN-P21:67) of 0-20 ml/min.

127. A board product as set forth in any of claims 116-124, characterized in that the topliner has a PPS s10 roughness of 0.8-1.5 μm.

128. A board product as set forth in any of claims 116-124, characterized in that the topliner has a Hunter gloss of 40-65%.

129. A board product as set forth in any of claims 116-128, characterized in that its density (SCAN-P7:75) is 600-850 kg/m³.

130. A board product as set forth in any of claims 116-129, characterized in that it is pre-calendered with a single- or multi-nip machine and/or soft calender.

131. A board product as set forth in any of claims 116-130, characterized in that its pre-calendering has involved board surface moistening.

132. A board product as set forth in any of claims 116-130, characterized in that its pre-calendering has not involved board surface moistening.

133. A method for making a coated board product, said board product comprising two or more fiber layers and having its surface layers consisting of bleached chemical pulp and its middle layers of mechanical pulp and/or broke, and said board having a basis weight of 150-400 g/m², characterized in that the method comprises passing a web to be coated for pre-calendering to a processing device as set forth in claim 1, comprising a belt (2) adapted to extend around a guiding element (3), at least one counter-element (5) being disposed outside said belt to provide a contact area with the belt, such that the belt (2) and the counter-element (5) establish therebetween a web processing zone for passing a web to be processed therethrough, the processing zone length in said processing device being defined by means of the disposition/adjustment of the belt's (2) guiding element (3) and/or the design of the counter-elements (5), that the web dwell time in the processing zone is within the range of about 0-1000 ms, and that a contact pressure applied to the web in the processing zone is adjusted to lie within the range of about 0.01 MPa to about 70 MPa.

134. A method as set forth in claim 133, characterized in that the web dwell time in the processing zone is within the range of 60-200 ms.

135. A method as set forth in claim 133 or 134, characterized in that pre-calendering involves the use of surface moistening.

136. Safety paper, which is formed of a calendered fibrous web (W), characterized in that, in the process of calendering the fibrous web (W), at least one side thereof is left with areas (7) of a desired shape uncalendered or less calendered, said uncalendered or less calendered areas (7) being clearly distinctive from the rest of the calendered surface of the fibrous web (W).

137. A method for producing safety paper formed of a calendered fibrous web (W), characterized in that, at least in one calendering process of the fibrous web (W), at least one side thereof is left with areas (7) of a desired shape uncalendered or less calendered, said uncalendered or less calendered areas (7) being clearly distinctive from the rest of the calendered surface of the fibrous web (W).

138. A method as set forth in claim 137 for producing safety paper formed of a calendered fibrous web (W), characterized in that said at least one calendering process for producing safety paper and for creating areas consistent with the shape of desired designs in the fibrous web (W) takes place in the final calendering process of a paper or board machine.

139. A calender for making safety paper from a fibrous web (W), characterized in that at least one calendering surface of the calender is provided with impressions (136) complementary to areas intended for the surface of the fibrous web (W) and consistent with the shape of desired designs, such that, in the process of calendering the fibrous web (W), the areas in the fibrous web (W) coinciding with the impressions (136) are left uncalendered or less calendered, said uncalendered or less calendered areas (137) being clearly distinctive from the rest of the calendered surface of the fibrous web (W).

140. A calender as set forth in claim 139 for making safety paper formed of a calendered fibrous web (W), characterized in that the calender comprises a belt (2) adapted to extend around a guiding element (3), at least one counter-element (5) being disposed outside said belt to provide a contact area with the belt, such that the belt (2) and the counter-element (5) establish therebetween a web processing zone for passing a web to be treated therethrough, and that the belt (2) and/or the counter-element (5) are/is provided with impressions (6) for creating areas (7) consistent with the shape of desired designs in the to-be-calendered fibrous web (W).

141. A device as set forth in claim 140, characterized in that the belt (2) comprises a metal belt.

142. A processing device as set forth in claim 1, characterized in that the processing device comprises an on-line or off-line device.
